(19) United States
(12) Patent Application Publication
(10) Pub. No.: US 2019/0005195 A1
(43) Pub. Date: Jan. 3, 2019

(54) METHODS AND SYSTEMS FOR IMPROVING CARE THROUGH POST-OPERATION FEEDBACK ANALYSIS

(71) Applicant: General Electric Company, Schenectady, NY (US)

(72) Inventors: Marcia Peterson, Barrington, IL (US); Sonny Chouinard, Terrebonne (CA)

(21) Appl. No.: 15/635,761

(22) Filed: Jun. 28, 2017

(51) Int. Cl. G06F 19/00; G06N 3/00

(52) U.S. Cl. CPC G06F 19/322; G06F 19/321; G06F 19/3431; G06F 19/327; G06F 19/3406; G06N 3/006

(57) ABSTRACT

Methods and apparatus providing a patient digital twin are disclosed. An example apparatus including an example patient digital twin includes a data structure created from a combination of patient electronic medical record data and historical information, the combination extracted from information system(s) and arranged in the data structure to form a digital representation of the patient. The example patient digital twin is arranged for query and simulation. The example patient digital twin is to receive feedback regarding the patient following a procedure conducted on the patient. The example patient digital twin is to incorporate the feedback into the patient digital twin when elements for the procedure have been completed. The example patient digital twin is to process the incorporated feedback to generate and output a recommendation for follow-up with respect to the patient based on the digital representation of the patient including the incorporated feedback with respect to the procedure conducted.

### FIELD OF THE DISCLOSURE

This disclosure relates generally to improved patient modeling and care and, more particularly, to improved systems and methods for improving patient care through post-operation feedback analysis, such as using a digital twin.

### BACKGROUND

A variety of economic, technological, and administrative hurdles challenge healthcare facilities, such as hospitals, clinics, doctors' offices, etc., to provide quality care to patients. Economic drivers, evolving medical science, less and skilled staff, fewer staff, complicated equipment, and emerging accreditation for controlling and standardizing radiation exposure dose usage across a healthcare enterprise create difficulties for effective management and use of imaging and information systems for examination, diagnosis, and treatment of patients.

Healthcare provider consolidations create geographically distributed hospital networks in which physical contact with systems is too costly. At the same time, referring physicians want more direct access to supporting data in reports and other data forms along with better channels for collaboration. Physicians have more patients, less time, and are inundated with huge amounts of data, and they are eager for assistance.

### BRIEF SUMMARY

Certain examples provide an apparatus including a processor and a memory. The example processor is to configure the memory according to a patient digital twin of a first patient. The example patient digital twin includes a data structure created from a combination of patient electronic medical record data and historical information, the combination extracted from one or more information systems and arranged in the data structure to form a digital representation of the first patient. The example patient digital twin is arranged for query and simulation via the processor. The example patient digital twin is to receive feedback regarding the first patient following a procedure conducted on the first patient. The example patient digital twin is to incorporate the feedback into the patient digital twin when elements for the procedure have been completed. The example patient digital twin is to process the incorporated feedback to generate and output a recommendation for follow-up with respect to the first patient based on the digital representation of the first patient including the incorporated feedback with respect to the procedure conducted on the first patient.

Certain examples provide a computer-readable storage medium including instructions which, when executed by a processor, cause a machine to implement an apparatus. The example apparatus includes at least a patient digital twin of a first patient, the patient digital twin including a data structure created from a combination of patient electronic medical record data and historical information, the combination extracted from one or more information systems and arranged in the data structure to form a digital representation of the first patient, the patient digital twin arranged for query and simulation via the processor. The example patient digital twin is to receive feedback regarding the first patient following a procedure conducted on the first patient. The example patient digital twin is to incorporate the feedback into the patient digital twin when elements for the procedure have been completed. The example patient digital twin is to process the incorporated feedback to generate and output a recommendation for follow-up with respect to the first patient based on the digital representation of the first patient including the incorporated feedback with respect to the procedure conducted on the first patient.

Certain example provide a method including generating, using a processor, a patient digital twin of a first patient, the patient digital twin including a data structure created from a combination of patient electronic medical record data and historical information, the combination extracted from one or more information systems and arranged in the data structure to form a digital representation of the first patient, the patient digital twin arranged for query and simulation via the processor. The example method includes receiving, via the patient digital twin, feedback regarding the first patient following a procedure conducted on the first patient. The example method includes incorporating, via the patient digital twin, the feedback into the patient digital twin when elements for the procedure have been completed. The example method includes processing, via the patient digital twin, the incorporated feedback to generate and output a recommendation for follow-up with respect to the first patient based on the digital representation of the first patient including the incorporated feedback with respect to the procedure conducted on the first patient.

### BRIEF DESCRIPTION OF THE DRAWINGS

FIG. 1 illustrates a patient in a real space providing data to a digital twin in a virtual space.

FIG. 2 illustrates an example implementation of a patient digital twin.

FIG. 3 illustrates an example relationship between a patient digital twin and advanced coordinated technologies to achieve patient outcomes.

FIG. 4 illustrates an example model of digital medical knowledge such as provided to/forming part of the digital twin in the example of FIG. 3.

FIG. 5 illustrates an example model of access to care such as provided to/forming part of the digital twin in the example of FIG. 3.

FIG. 6 illustrates an example model of behavioral choices such as provided to/forming part of the digital twin in the example of FIG. 3.

FIG. 7 illustrates an example model of environmental factors or social determinants such as provided to/forming part of the digital twin in the example of FIG. 3.

FIG. 8 illustrates an example model of cost such as provided to/forming part of the digital twin in the example of FIG. 3.

FIG. 9 illustrates an example process for patient monitoring using a patient digital twin.

FIG. 10 illustrates an example system for patient monitoring using a patient digital twin.

FIG. 11 illustrates a flow diagram of an example method to generate and update a patient digital twin.

FIG. 12 illustrates a flow diagram of an example method to create a patient digital twin.

FIG. 13 illustrates an example application of the patient digital twin to patient health outcome(s).

FIGS. 14-16 illustrate flow diagrams of example methods to create and update the patient digital twin.

FIG. 17 illustrates an example process using an evidence-based patient digital twin for improved care planning and outcomes.

FIG. 18 illustrates an example healthcare ecosystem.

FIG. 19 illustrates an example healthcare system architecture accessible via a portal at a computing device at a healthcare facility and/or mobile device.

FIG. 20 is a representation of an example deep learning neural network that can be used to implement the patient digital twin.

FIG. 21 shows a block diagram of an example healthcare-focused information system.

FIG. 22 shows a block diagram of an example healthcare information infrastructure.

FIG. 23 illustrates an example industrial internet configuration.

FIG. 24 is a block diagram of a processor platform structured to execute the example machine readable instructions to implement components disclosed and described herein.

FIGS. 25-32 illustrate example graphical user interfaces to facilitate input and use of post-operative and/or other feedback with respect to the patient digital twin and/or other electronic medical record and/or clinical system.

The figures are not scale. Wherever possible, the same reference numbers will be used throughout the drawings and accompanying written description to refer to the same or like parts.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

While certain examples are described below in the context of medical or healthcare systems, other examples can be implemented outside the medical environment. For example, certain examples can be applied to non-medical imaging such as non-destructive testing, explosive detection, etc.

### I. Overview

A digital representation, digital model, digital “twin”, or digital “shadow” is a digital informational construct about a physical system. That is, digital information can be implemented as a “twin” of a physical device/system/person and information associated with and/or embedded within the physical device/system. The digital twin is linked with the physical system through the lifecycle of the physical system. In certain examples, the digital twin includes a physical object in real space, a digital twin of that physical object that exists in a virtual space, and information linking the physical object with its digital twin. The digital twin exists in a virtual space corresponding to a real space and includes a link for data flow from real space to virtual space as well as a link for information flow from virtual space to real space and virtual sub-spaces.

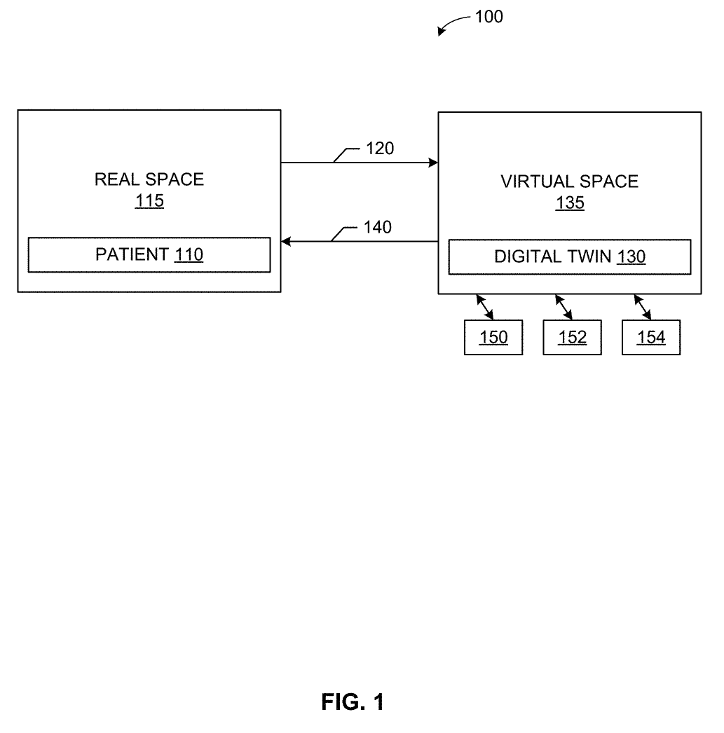

For example, FIG. 1 illustrates a patient 110 in a real space 115 providing data 120 to a digital twin 130 in a virtual space 135. The digital twin 130 and/or its virtual space 135 provide information 140 back to the real space 115. The digital twin 130 and/or virtual space 135 can also provide information to one or more virtual sub-spaces 150, 152, 154. As shown in the example of FIG. 1, the virtual space 135 can include and/or be associated with one or more virtual sub-spaces 150, 152, 154, which can be used to model one or more parts of the digital twin 130 and/or digital “sub-twins” modeling subsystems/subparts of the overall digital twin 130.

Sensors connected to the physical object (e.g., the patient 110) can collect data and relay the collected data 120 to the digital twin 130 (e.g., via self-reporting, using a clinical or other health information system such as a picture archiving and communication system (PACS), radiology information system (RIS), electronic medical record system (EMR), laboratory information system (LIS), cardiovascular information system (CVIS), hospital information system (HIS), and/or combination thereof, etc.). Interaction between the digital twin 130 and the patient 110 can help improve diagnosis, treatment, health maintenance, etc., for the patient 110, for example. An accurate digital description 130 of the patient 110 benefiting from a real-time or substantially real-time (e.g., accounting from data transmission, processing, and/or storage delay) allows the system 100 to predict “failures” in the form of disease, body function, and/or other malady, condition, etc.

In certain examples, obtained images overlaid with sensor data, lab results, etc., can be used in augmented reality (AR) applications when a healthcare practitioner is examining, treating, and/or otherwise caring for the patent 110. Using AR, the digital twin 130 follows the patient's response to the interaction with the healthcare practitioner, for example.

Thus, rather than a generic model, the digital twin 130 is a collection of actual physics-based, anatomically-based, and/or biologically-based models reflecting the patient 110 and his or her associated norms, conditions, etc. In certain examples, three-dimensional (3D) modeling of the patient 110 creates the digital twin 130 for the patient 110. The digital twin 130 can be used to view a status of the patient 110 based on input data 120 dynamically provided from a source (e.g., from the patient 110, practitioner, health information system, sensor, etc.).

In certain examples, the digital twin 130 of the patient 110 can be used for monitoring, diagnostics, and prognostics for the patient 110. Using sensor data in combination with historical information, current and/or potential future conditions of the patient 110 can be identified, predicted, monitored, etc., using the digital twin 130. Causation, escalation, improvement, etc., can be monitored via the digital twin 130. Using the digital twin 130, the patient's 110 physical behaviors can be simulated and visualized for diagnosis, treatment, monitoring, maintenance, etc.

In contrast to computers, humans do not process information in a sequential, step-by-step process. Instead, people try to conceptualize a problem and understand its context. While a person can review data in reports, tables, etc., the person is most effective when visually reviewing a problem and trying to find its solution. Typically, however, when a person visually processes information, records the information in alphanumeric form, and then tries to re-conceptualize the information visually, information is lost and the problem-solving process is made much less efficient over time.

Using the digital twin 130, however, allows a person and/or system to view and evaluate a visualization of a situation (e.g., a patient 110 and associated patient problem, etc.) without translating to data and back. With the digital twin 130 in common perspective with the actual patient 110, physical and virtual information can be viewed together, dynamically and in real time (or substantially real time accounting for data processing, transmission, and/or storage delay). Rather than reading a report, a healthcare practitioner can view and simulate with the digital twin 130 to evaluate a condition, progression, possible treatment, etc., for the patient 110. In certain examples, features, conditions, trends, indicators, traits, etc., can be tagged and/or otherwise labeled in the digital twin 130 to allow the practitioner to quickly and easily view designated parameters, values, trends, alerts, etc.

The digital twin 130 can also be used for comparison (e.g., to the patient 110, to a “normal”, standard, or reference patient, set of clinical criteria/symptoms, etc.). In certain examples, the digital twin 130 of the patient 110 can be used to measure and visualize an ideal or “gold standard” value state for that patient, a margin for error or standard deviation around that value (e.g., positive and/or negative deviation from the gold standard value, etc.), an actual value, a trend of actual values, etc. A difference between the actual value or trend of actual values and the gold standard (e.g., that falls outside the acceptable deviation) can be visualized as an alphanumeric value, a color indication, a pattern, etc.

Further, the digital twin 130 of the patient 110 can facilitate collaboration among friends, family, care providers, etc., for the patient 110. Using the digital twin 130, conceptualization of the patient 110 and his/her health can be shared (e.g., according to a care plan, etc.) among multiple people including care providers, family, friends, etc. People do not need to be in the same location as the patient 110, with each other, etc., and can still view, interact with, and draw conclusions from the same digital twin 130, for example.

Thus, the digital twin 130 can be defined as a set of virtual information constructs that describes (e.g., fully describes) the patient 110 from a micro level (e.g., heart, lungs, foot, anterior cruciate ligament (ACL), stroke history, etc.) to a macro level (e.g., whole anatomy, holistic view, skeletal system, nervous system, vascular system, etc.). In certain examples, the digital twin 130 can be a reference digital twin (e.g., a digital twin prototype, etc.) and/or a digital twin instance. The reference digital twin represents a prototypical or “gold standard” model of the patient 110 or of a particular type/category of patient 110, while one or more reference digital twins represent particular patients 110. Thus, the digital twin 130 of a child patient 110 may be implemented as a child reference digital twin organized according to certain standard or “typical” child characteristics, with a particular digital twin instance representing the particular child patient 110. In certain examples, multiple digital twin instances can be aggregated into a digital twin aggregate (e.g., to represent an accumulation or combination of multiple child patients sharing a common reference digital twin, etc.). The digital twin aggregate can be used to identify differences, similarities, trends, etc., between children represented by the child digital twin instances, for example.

In certain examples, the virtual space 135 in which the digital twin 130 (and/or multiple digital twin instances, etc.) operates is referred to as a digital twin environment. The digital twin environment 135 provides an integrated, multi-domain physics- and/or biologics-based application space in which to operate the digital twin 130. The digital twin 130 can be analyzed in the digital twin environment 135 to predict future behavior, condition, progression, etc., of the patient 110, for example. The digital twin 130 can also be interrogated or queried in the digital twin environment 135 to retrieve and/or analyze current information 140, past history, etc.

In certain examples, the digital twin environment 135 can be divided into multiple virtual spaces 150-154. Each virtual space 150-154 can model a different digital twin instance and/or component of the digital twin 130 and/or each virtual space 150-154 can be used to perform a different analysis, simulation, etc., of the same digital twin 130. Using the multiple virtual spaces 150-154, the digital twin 130 can be tested inexpensively and efficiently in a plurality of ways while preserving patient 110 safety. A healthcare provider can then understand how the patient 110 may react to a variety of treatments in a variety of scenarios, for example.

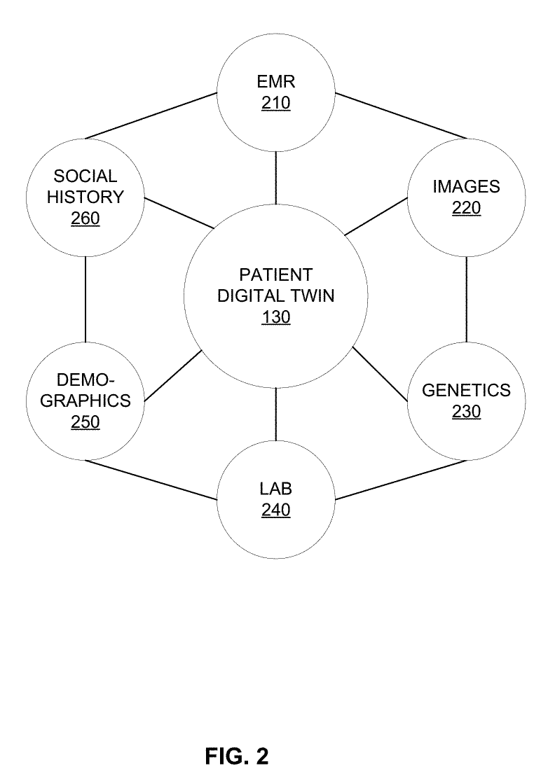

FIG. 2 illustrates an example implementation of the patient digital twin 130. The patient digital twin 130 includes electronic medical record (EMR) 210 information, images 220, genetic data 230, laboratory results 240, demographic information 250, social history 260, etc. As shown in the example of FIG. 2, the patient digital twin 130 is fed from a plurality of data sources 210-260 to model the patient 110. Using the plurality of sources of patient 110 information, the patient digital twin 130 can be configured, trained, populated, etc., with patient medical data, exam records, patient and family history, lab test results, prescription information, friend and social network information, image data, genomics, clinical notes, sensor data, location data, etc.

When a user (e.g., the patient 110, patient family member (e.g., parent, spouse, sibling, child, etc.), healthcare practitioner (e.g., doctor, nurse, technician, administrator, etc.), other provider, payer, etc.) and/or program, device, system, etc., inputs data in a system such as a picture archiving and communication system (PACS), radiology information system (RIS), electronic medical record system (EMR), laboratory information system (LIS), cardiovascular information system (CVIS), hospital information system (HIS), population health management system (PHM) etc., that information is reflected in the digital twin 130. Thus, the patient digital twin 130 can serve as an overall model or avatar of the patient 110 and can also model particular aspects of the patient 110 corresponding to particular data source(s) 210-260. Data can be added to and/or otherwise used to update the digital twin 130 via manual data entry and/or wired/wireless (e.g., WiFi™, Bluetooth™, Near Field Communication (NFC), radio frequency, etc.) data communication, etc., from a respective system/data source, for example. Data input to the digital twin 130 is processed by an ingestion engine and/or other processor to normalize the information and provide governance and/or management rules, criteria, etc., to the information. In addition to building the digital twin 130, some or all information can also be aggregated for population-based health analytics, management, etc.

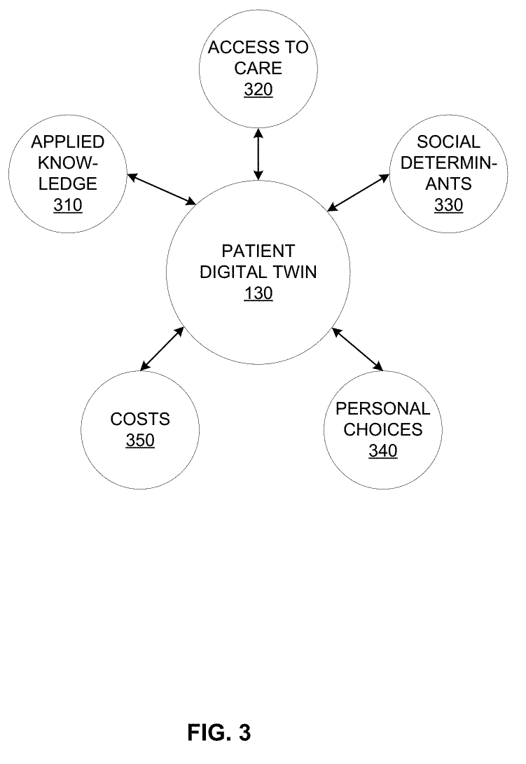

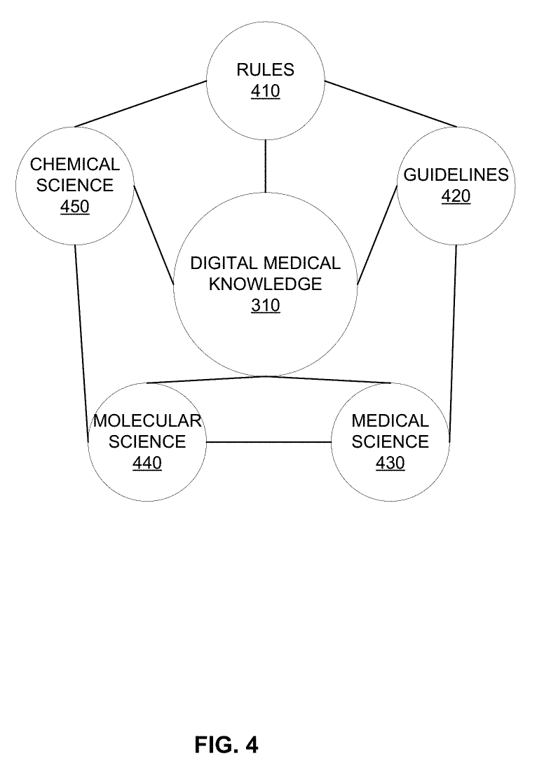

FIG. 3 illustrates an example relationship between the patient digital twin 130 and advanced coordinated technologies to achieve patient outcomes. The patient digital twin 130 can be used to apply patient-related heterogenous data with artificial intelligence (e.g., machine learning, deep learning, etc.) and digitized medical knowledge to enable health outcomes. As shown in the example of FIG. 3, the patient digital twin 130 can be used to drive applied knowledge 310, access to care 320, social determinants 330, personal choices 340, costs 350, etc. FIGS. 4-8 provide further detail regard each of the elements 310-350 of the example patient digital twin 130 of FIG. 3.

As modeled with the digital twin 130 in the example of FIG. 3, a health outcome can be determined as follows:

$$\frac{\begin{matrix}[ Patient Digital Twin ] + \\ [ Digital Medical Knowledge ] + [ Access to Care ]\end{matrix}}{\begin{matrix}[ Behavioral Choices ] + \\ [ Social / Physical Environment ] + [ Costs ]\end{matrix}} = Health Outcomes . \qquad ( Eq . 1 )$$

In certain examples, a solutions architecture of collaboration connecting workflows driven by analytics running on a cloud and/or on-premise platform can facilitate determination of health outcomes using the patient digital twin 130 and Equation 1.

FIG. 4 illustrates an example model of digital medical knowledge 310 such as provided to/forming part of the digital twin 130 in the example of FIG. 3. As shown in the example of FIG. 4, digital medical knowledge 310 sources include rules 410, guidelines 430, medical science 430, molecular science 440, chemical science 450, etc. Example digital medical knowledge 310 sources includes clinical evidence, other literature, algorithms, processing engines, other governance and management, etc. Information from the sources 410-450 can form part of the digital medical knowledge 310 enhancing the patient digital twin 130.

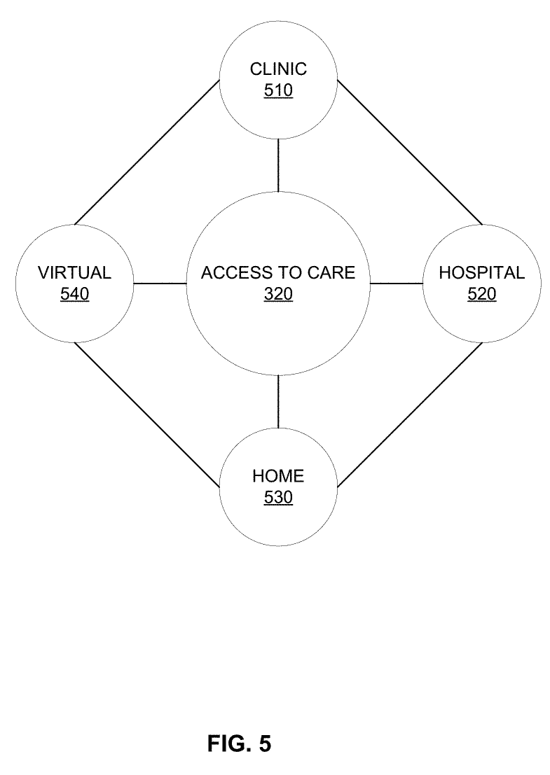

FIG. 5 illustrates an example model of access to care 320 such as provided to/forming part of the digital twin 130 in the example of FIG. 3. As shown in the example of FIG. 5, information regarding access to care 320 includes clinic access 510, hospital access 520, home access 530, telemedicine access 540, etc. Information regarding access to care can include and/or be generated by clinicians and/or other healthcare practitioners associated with the patient 110. In certain examples, a plurality of systems such as workflow, communications, collaboration, etc., can impact access to care 320 by the patient 110. Such systems can be modeled at the clinical 510, hospital 520, home, and telemedicine 540 level via the patient digital twin 130. Such systems can provide information to the digital twin 130, for example.

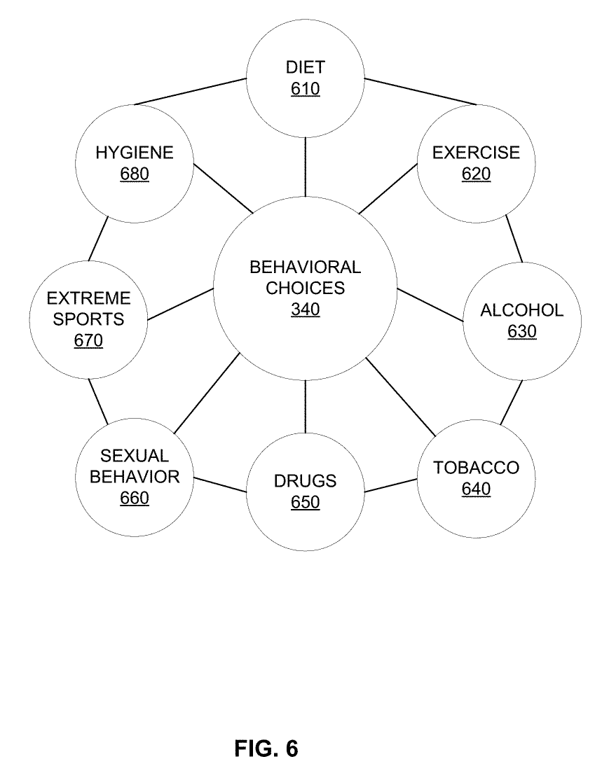

FIG. 6 illustrates an example model of behavioral choices 340 such as provided to/forming part of the digital twin 130 in the example of FIG. 3. As shown in the example of FIG. 6, information regarding behavioral choices 340 includes diet 610, exercise 620, alcohol 630, tobacco 640, drugs 650, sexual behavior 660, extreme sports 670, hygiene 680, etc. Behavioral information 610-680 can be provided by the patient 110, clinicians, other healthcare practitioners, coaches, social workers, family, friends, etc. Additionally, behavioral information 610-680 can be provided by medical devices, monitoring devices, biometric sensors, locational sensors, communication systems, collaboration systems, etc. Behavioral choices 340 observed in and/or documented with respect to the patient 110 can be reflected in the patient's digital twin 130, and rules, consequences, and/or other outcomes of certain behaviors 610-680 can be modeled via the digital twin 130, for example.

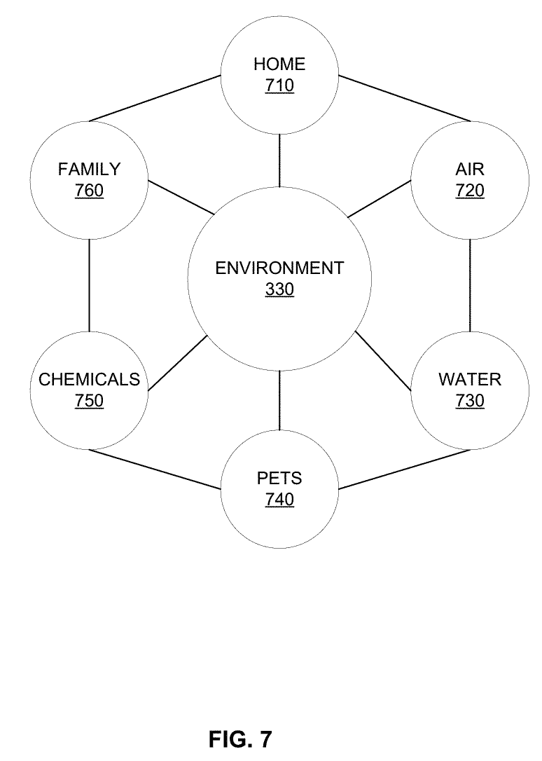

FIG. 7 illustrates an example model of environmental factors or social determinants 330 such as provided to/forming part of the digital twin 130 in the example of FIG. 3. As shown in the example of FIG. 7, information regarding environmental factors 330 can include home 710, air 720, water 730, pets 740, chemicals 750, family 760, etc. Thus, one or more social/environmental factors 330 can be modeled for the patient 110 via the patient's digital twin 130. In certain examples, community resources, medical devices, monitoring devices, biometric sensors, locational sensors, communication systems, collaboration systems, etc., can be used to measure and/or otherwise capture social/environmental information 330 to be modeled via the patient digital twin 130, for example. Social/environmental factors 710-760 can influence patient 110 behavior, health, recovery, adherence to protocol, etc., and such factors 710-760 can be modeled by the digital twin 130, for example.

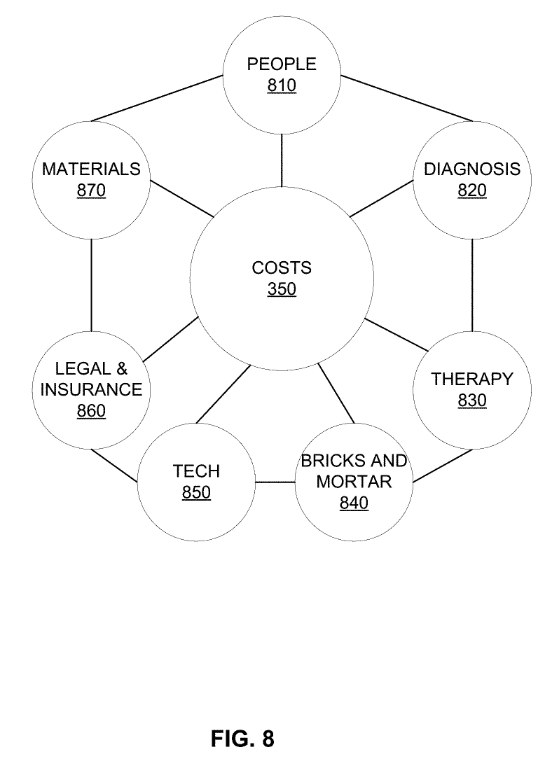

FIG. 8 illustrates an example model of costs 350 such as provided to/forming part of the digital twin 130 in the example of FIG. 3. As shown in the example of FIG. 8, information regarding costs 350 can include people 810, diagnosis 820, therapy 830, bricks and mortar 840, technology 850, legal and insurance 860, materials 870, etc. Thus, one or more costs 350 can be modeled for the patient 110 via the patient's digital twin 130. Estimated cost 350 associated with a particular recommendation for action, treatment, prevention, etc., can be evaluated based at least in part on cost 350 via the patient digital twin 130. An estimate of current cost 350 for the patient 110 can be calculated and tracked via the digital twin 130, for example. Costs 350 such as people 810, diagnosis 820, therapy 830, bricks and mortar 840, technology 850, legal and insurance 860, materials 870, etc., can be captured, output, and/or evaluated using one or more data sources, people, systems, etc. For example, data sources such as settings, supply chain information, people, operations, etc., can provide cost 350 information. People in a variety of roles and/or settings can provide cost 350 information, for example. Systems such as clinical systems, financial systems, operational systems, analytical systems, etc., can provide and/or leverage cost 350 information, for example. Thus, expenses for people (e.g., healthcare practitioners, care givers, family, etc.) 810, diagnosis (e.g., laboratory tests, images, etc.) 820, therapy (e.g., physical therapy, mental therapy, occupational therapy, etc.) 830, bricks and mortar (e.g., rent, lodging, transportation, etc.) 840, technology (e.g., sensors, medical devices, computer, etc.) 850, legal and insurance (e.g., attorney fees, health insurance, etc.) 860, materials (e.g., test strips, kits, first aid supplies, ambulatory aids, etc.) 870, etc., can be modeled via the digital twin 130 and/or can serve as input to refine/improve the model of the digital twin 130 for the patient (e.g., including via simulation and/or other “what if” analysis, etc.).

Thus, as recited in Equation 1, a combination of the patient digital twin 130 modeled with digital medical knowledge 310 and access to care 320, bounded by behavioral choices 340, social/physical environment 330 and cost 350, provides a prediction, estimation, and/or other determination of health outcome for the patient 110. Such a combination represents a technological improvement in computer-aided diagnosis and treatment of patients, as the patient digital twin 130 represents a new and improved data structure and automated, electronic correlation with digital medical knowledge 310 and access to care 320, bounded by behavioral choices 340, social/physical environment 330 and cost 350, enables modeling, simulation, and identification of potential issues and possible solutions not feasible when done manually by a clinician or by prior computing systems, which were unable to model and simulate as the patient digital twin 130 disclosed and described herein.

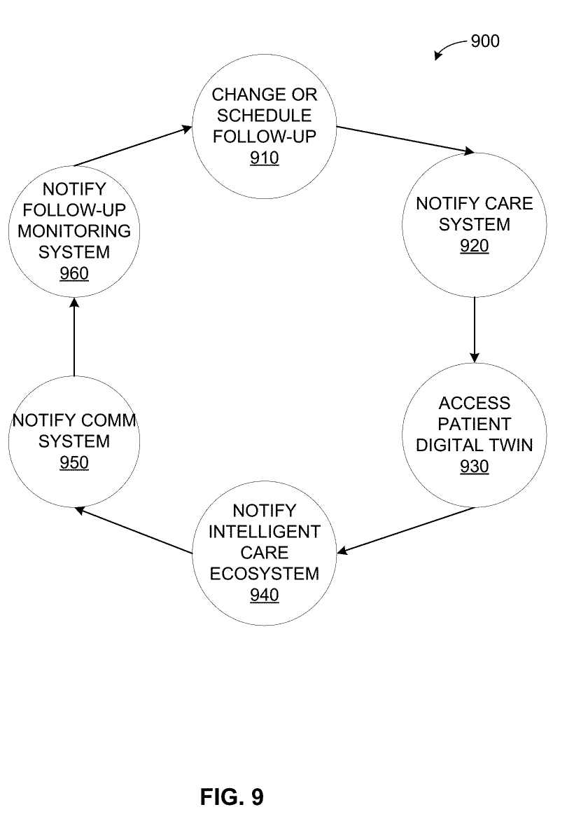

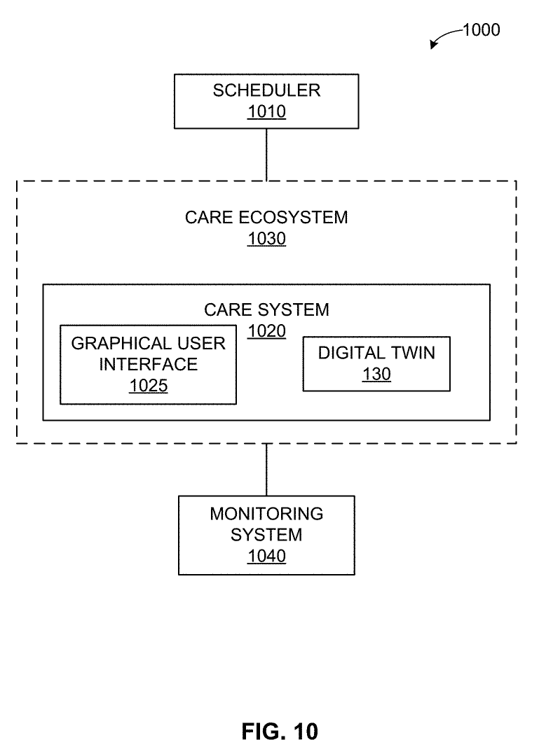

The patient digital twin 130 can be used to help drive a continuous loop of patient care such as shown in the example of FIG. 9. FIG. 9 illustrates an example process 900 for patient 110 monitoring using the digital twin 130. At block 910, a change or scheduled follow-up is initiated. One or more pre-scheduled measures can be taken in conjunction with the change or scheduled follow-up event, for example. The patient 110 is detected and one or more associated devices are detected as part of the follow-up event, for example. The change can be facilitated by a scheduler (e.g., scheduler 1010 (e.g., EMR, electronic health record (EHR), personal health record (PHR), calendar program, etc.) in the example system 1000 of FIG. 10) in conjunction with the patient's digital twin 130, for example.

At block 920, a care system (e.g., care system 1020 shown in FIG. 10) is notified. For example, the care system 1020 can be notified via voice, text, data stream, etc., (e.g., from the scheduler 1010, etc.) regarding the change/scheduled follow-up. The care system 1020 can include an EMR, EHR, PHR, PHM, PACS, RIS, CVIS, LIS, HIS, etc., and/or other scheduling system, for example.

At block 930, the patient digital twin 130 is accessed. For example, the patient digital twin 130 can be stored on the care system 1020 and/or otherwise can be accessed via the care system 1020 (e.g., via a graphical user interface 1025 display of the care system 1020, etc.) to communicate the change and/or other scheduling of the follow-up event. Thus, a change in exam time and/or other scheduling of a follow-up exam can be incorporated in the digital twin 130 (e.g., to model patient 110 behavior leading up to the event, process information obtained/changed after the event, etc.) and ingested as part of the digital twin 130 avatar or model.

At block 940, an intelligent care ecosystem associated with the digital twin 130 is notified. The care ecosystem (e.g., care ecosystem 1030 of the example of FIG. 10) can include the care system 1020 and/or other system (e.g., an EMR, EHR, PHR, PHM, PACS, RIS, CVIS, LIS, HIS, etc.) associated with the digital twin 130, appointment, etc. Via the care ecosystem 1030, one or more algorithms can be run on, in, or with respect to the patient digital twin 130, for example. Execution of the algorithms via the intelligent care ecosystem 1030 using the digital twin 130 creates output(s) that can be synthesized to be provided to the digital twin 130 and/or other system, for example. In certain examples, an action plan (e.g., a patient care plan, etc.) can be created from the synthesized output. The action plan can be incorporated into the patient digital twin 130, for example, to model the patient's 110 response to the action plan, for example. Communication can occur according to patient preference(s) (e.g., text, voice, email, etc., to one or more numbers/addresses, etc.). Additionally, care team members involved in the action plan can be notified according to care team preferences. For example, if the action plan for the patient 110 involves a radiologist, a lab technician, and a primary physician forming the care team, those members are notified according to their contact preferences (e.g., text, voice, email, etc., to one or more numbers/addresses, etc.). Thus, a coordinated care action plan for the patient 110 can be communicated to authorized stakeholders, for example.

At block 960, a follow-up monitoring system is notified (e.g., monitoring system 1040 of the example of FIG. 10). For example, multi-stakeholder workflow systems are activated and system(s) (e.g., EMR, EHR, PHR, PHM, PACS, RIS, CVIS, LIS, HIS, calendar/scheduling system, etc.) associated with care team member(s), the patient 110, etc., can be notified of the schedule/event.

The process 900 can then loop upon the next change to allow the patient digital twin 130 to be updated and associated care plan, care systems, and care team members to react to the new notification. Thus, the digital twin 130 can be dynamically updated, receiving new information and driving associated health systems to monitor and treat the patient 110.

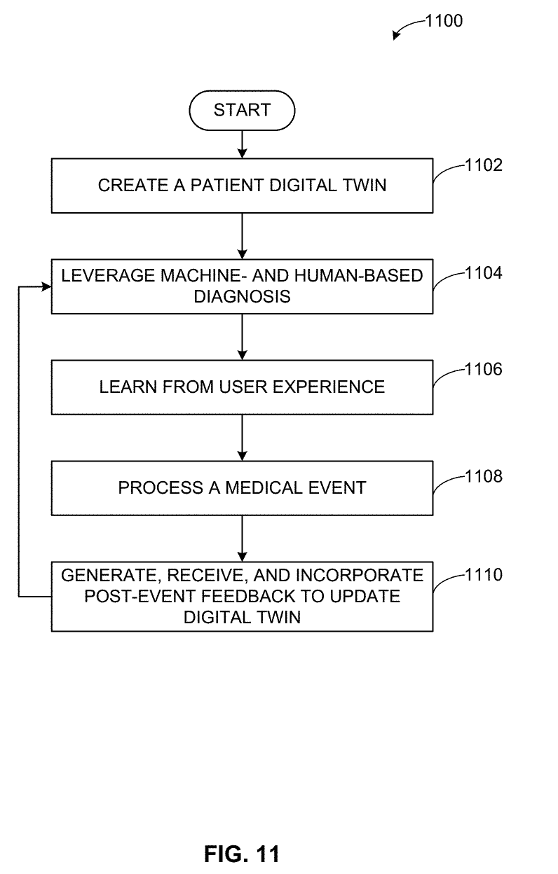

FIG. 11 illustrates a flow diagram of an example method 1100 to generate and update a patient digital twin. At block 1102, a patient digital twin 130 is created. For example, a digital representation is formed from available information for the patient. The digital representation forming the digital twin 130 can be extracted from a plurality of available sources, such as sensor data, patient 110 input, family and/or friend input, EMR records, lab results, image data, etc. In certain examples, the digital twin 110 includes a visual, digital representation of the patient 110 with information overlaid on the visual representation (e.g., as dots and/or other indicators on the visual representation, etc.).

At block 1104, machine- and human-based diagnosis is leveraged to improve the patient digital twin 130. For example, healthcare software applications, medical big data, neural networks, other machine learning and/or artificial intelligence, etc., can be leveraged to diagnose, identify issue(s), propose solution(s) (e.g., medication, diagnosis, treatment, etc.) with respect to the digital twin 130. In certain examples, a remote human specialist can be consulted. The clinician can see results of the patient digital twin 130 and machine-based analysis and provide a final diagnosis and next steps for the patient 110, for example.

At block 1106, feedback can be obtained based on user experience to augment the digital twin 130. User experience with conditions, procedures, etc., similar to those of the patient 110 can be provided to the digital twin 130. Feedback regarding user experience with the digital twin 130 can also be provided. Feedback from user experience can be used to generate tips/suggestions, instructions, etc., that can be incorporated in the digital twin 130, provided to a user, etc.

At block 1108, a medical event (e.g., surgery, image acquisition, real or virtual office visit, other procedure, etc.) is processed with respect to the patient digital twin 130. For example, image data, sensor data, observations, test results, etc., from a medical event is processed with respect to information and/or modeling of the patient digital twin 130. Image data can be processed to form image analysis, computer aided detection, image quality determination, etc. Sensor data can be processed to identify a value, change, difference with respect to a threshold, etc. Test results can be processed in comparison to a threshold, etc., based on the digital twin 130.

At block 1110, post-event feedback is generated, received, and incorporated to update the patient digital twin 130. Feedback generated from image analysis, sensor data evaluation, test results, human feedback, etc., can represent post-event feedback to be provided to the digital twin 130 for improved modeling, parameter modification, etc. Once the digital twin 130 has been updated, the process 1000 reverts to block 1104 to await further diagnosis.

Thus, the digital twin 130 can evolve over time based on available health data, machine-learning, human feedback, medical event processing, new or updated digital medical knowledge, and post-event feedback. The digital twin 130 provides an evolving model of the patient 110 that can learn and absorb information to reflect patient body systems and health information systems, rules, norms, best practices, etc. Using the patient digital twin 130, a healthcare practitioner may not need to consult with the patient 110. When a new piece of data comes in, the information is automatically analyzed and used to update the digital twin 130 and provide one or more recommendations and/or further actions based on the twin 130 modeled interactions.

In certain examples, as the digital twin 130 updates and evolves/improves over time, prior states of the digital twin 130 are saved. Thus, a prior state of the digital twin 130 can be retrieved and reviewed. For example, a physician can review digital twin 130 states over time to understand changes in the patient's 110 bodily function.

As described above, the patient digital twin 130 can be created (block 1102) by leveraging available patient information such as EMR 210, images 220, genetics 230, laboratory results 240, demographics 250, social history 260, etc. Machine learning and/or other artificial intelligence can be leveraged along with human diagnosis of the patient 110 to improve the digital twin 130 (block 1104). For example, applied knowledge 310, access to care 320, social determinants 330, personal choices 340, costs 350, etc., can be leveraged to improve the digital twin 130. Tips and/or instructions from user experience can also be incorporated to improve the digital twin 130 (block 1106). For example, digital medical knowledge 310 such as rules 410, guidelines 420, medical science 430, molecular science 440, chemical science 450, etc., can be used to improve the digital twin 130 as the knowledge relates to the patient information in the digital twin 130. The digital twin 130 is a new, improved data structure stored in memory that can then be used to respond to and/or anticipate a particular medical event (e.g., surgery, heart attack, diabetes, etc.) (block 1108). For example, digital medical knowledge 310 and access to care 320 can be used with the patient digital twin 130 to help a healthcare practitioner predict and/or respond to a medical event for the patient 110. After the event, feedback can be provided to the patient digital twin 130 and/or to a user via the digital twin 130 (block 1110), for example. In certain examples, algorithms, score cards, patient-defined communication preferences, etc., can be used to evolve the patient digital twin 130 and provide feedback regarding performance indicators and predictions for the patient 110 and/or group of patients (e.g., with same condition, same provider, same location, other commonality, etc.).

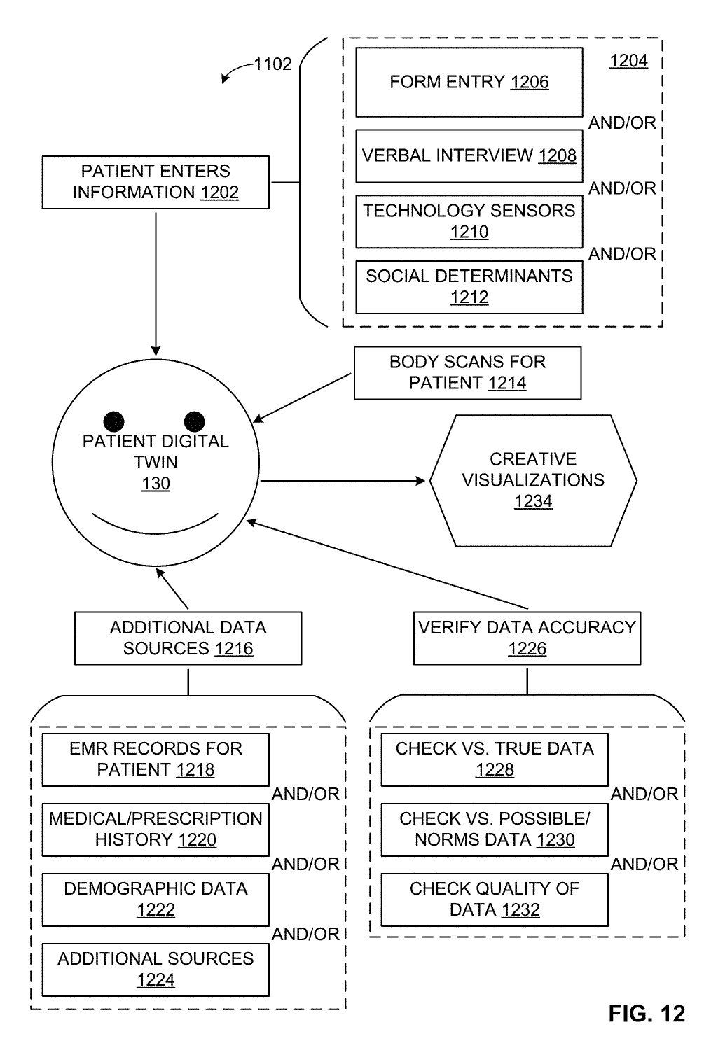

FIG. 12 illustrates a flow diagram of an example method 1200 to create the patient digital twin 130. At block 1202, patient 110 related information is entered for the digital twin 130. For example, the patient 110 can enter personal identifying information (e.g., gender, height, weight, age, social security number, etc.), medical history, family information, current symptom, etc. As shown in the example of FIG. 12, patient-related information entry (block 1202) can include entry from one or more sources 1204. For example, at block 1206, patient-related information can be entered via one or more forms. For example, a form can be provided via a computer- and/or mobile-based application to gather information from the patient 110 (e.g., a “form interview”). At block 1208, information can be obtained via a verbal interview. For example, a digital assistant (e.g., Amazon Alexa™, Apple Siri™, Microsoft Cortana™, etc.) can facilitate a verbal conversation to extract patient-related information. At block 1210, one or more technology sensors can be used to gather patient-related information. For example, digital meters, chair sensors, fitness trackers, exercise machines, smart scales, diabetes blood sugar test, and/or other health tracker can be connected to provide data for the patient digital twin 130. At block 1212, one or more social determinants, such as social network and/or other online information, can be leveraged to provide patient-related information for the digital twin 130. Thus, one or more of a plurality of sources 1204 can provide patient-related information for entry into the digital twin 130 at block 1202.

At block 1214, one or more images and/or other body scans of the patient 110 can be provided to form the patient digital twin 130. For example, one or more medical images such as x-ray, ultrasound, computed tomography (CT), magnetic resonance (MR), nuclear (NUC), position-emission tomography (PET), and/or other image can help to create the model of the patient digital twin 130. Airport body scans and/or other image data can also be added to create the digital twin 130. Imaging data can be used to form an avatar of the patient 110 for the patient digital twin 130 and/or can be used in combination with other patient data for simulation, diagnosis, etc.

At block 1216, one or more additional data sources can combine with the patient-related information (block 1202) and image information (block 1214) to create the digital twin 130 for the patient 110. For example, at block 1218, information from EMR and/or other medical records (e.g., EHR records, PHR records, etc.) for the patient 110 can be extracted to create the digital twin 130. At block 1220, medication/prescription history can be extracted to create the patient digital twin 130. For example, prescription information can be extracted from a pharmacy system and/or other medication information (e.g., dosage, frequency, reactions, etc.) can be extracted from another information source (e.g., EMR, EHR, PHR, etc.) to supplement the patient digital twin 130. At block 1222, demographic data can be extracted to create the patient digital twin 130. For example, population health information, patient demographics, family and/or friend demographics, neighborhood information, access to care data, etc., can be provided to form the patient digital twin 130 (e.g., from an EMR, EHR, PHR, enterprise archive, etc.). At block 1224, one or more additional sources can provide information to help create the patient digital twin 130.

At block 1226, data submitted and/or otherwise extracted to form the patient digital twin 130 is verified for accuracy. At block 1228, for example, input data is verified with respect to “true” data. For example, multiple instances of data are compared to evaluate the accuracy of the data. For example, a submitted piece of data can be compared against a previously verified piece of data to determine whether the submitted data matches and/or is consistent with the previously verified data. If the same information is provided from multiple sources, the information can be compared to help ensure its consistency. For example, information may have been mis-entered in the EMR but correctly provided in the patient interview. The patient 110 may have guessed at an answer, but the data may have been mathematically verified by the nurse before entry into the patient's chart, for example.

At block 1230, provided data is verified with respect to possible, “normal”, and/or reference data. For example, information can be evaluated to determine whether the information is reasonable, feasible, possible, etc. For example, a data entry indicating the patient 110 is 110 feet tall is determined not to be reasonable and is discarded from the patient digital twin 130. If another data source indicates the patient 110 is six feet tall, then that measurement can be used and the 110-feet measurement discarded, for example.

At block 1232, data quality can be evaluated. For example, patient image data can be evaluated according to a calculated image quality index. If the image data is not of sufficient quality (e.g., image quality index greater than or equal to a quality threshold, etc.), then the data can be discarded as not useful, unreliable, etc., for the patient digital twin 130, for example. As another example, form data may be incomplete, and if less than a certain percentage, number of fields, etc., has been completed, the information may be unable to drive reliable correlations. In certain examples, if input information does not satisfy a quality evaluation, a request can be generated to obtain another sample, another image, a higher quality of data, etc.

Based on the entered and verified information regarding the patient 110 and/or related to the patient 110, the digital twin 130 is created. For example, a neural network and/or other machine- and/or deep-learning construct is populated with inputs corresponding to the verified information and trained to become a deployable model of the patient 110. As another example, a new data structure is created to represent the patient 110 in various aspects. For example, a data structure can be formed representing the patient 110 digitally, and the data structure can include fields representing various body systems (e.g., nervous system, vascular system, muscular system, skeletal system, immune system, etc.) and/or other aspects of the patient 110. Alternatively or in addition, the data structure can be divided according to body system, patient history, environmental/social information, etc. (e.g., as shown in FIGS. 2, 3, etc.), for example.

In certain examples, a neural network, data structure, and/or other digital information construct can include multiple subsystems and/or other sub-instances forming part of the overall digital twin 130. For example, different patient 110 body systems (e.g., vascular, neural, musculoskeletal, immune, etc.) can be structured and modeled as separate networks, data structures, etc. In certain examples, the digital twin 130 can be implemented as a nested series of learning networks, data structures, etc., including an umbrella construct and subsystem constructs formed within the umbrella. Thus, the overall digital twin 130 and subsystems within the digital twin 130 can be stored, processed, modeled, and/or otherwise used with respect to patient 110 diagnosis, treatment, prediction, etc.

At block 1234, after information has been entered (blocks 1202, 1204, 1214, 1216) and verified (block 1226) to create the patient digital twin 130, the patient digital twin 130 can be leverage to create visualization(s) of patient 110 information. For example, the digital twin 130 can be used in simulation/emulation of the patient 110 and conditions experienced and/or likely to be experienced by the patient 110. In certain examples, the patient digital twin 130 can be visualized to a user as an avatar or other visual representation (e.g., two-dimensional, three-dimensional, four-dimensional (e.g., including a time component to simulate, navigate, etc., backward and/or forward in time), etc.) including patient information overlaid on human anatomy visualization, made available upon drilling down into a particular anatomy, etc.

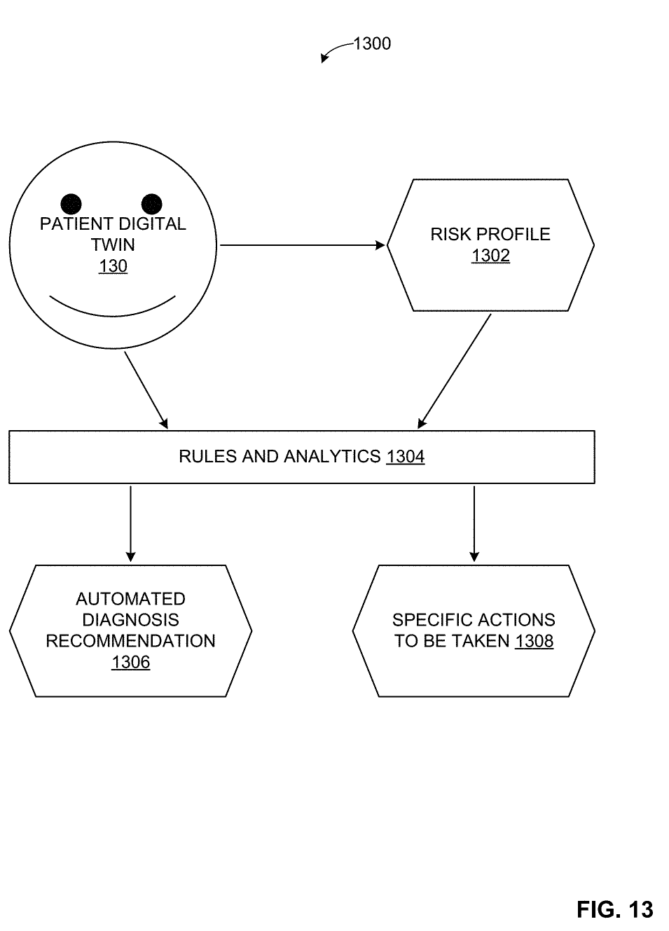

FIG. 13 illustrates an example application of the patient digital twin 130 to patient 110 health outcome(s). As shown in the example flow 1300 of FIG. 13, the patient digital twin 130 can be used to generate a risk profile 1302 for the patient 110. For example, based on information stored and/or otherwise modeled in the digital twin 130, the patient's 110 risk for certain conditions, diseases, etc., can be modeled to generate the patient's risk profile 1302. The risk profile 1302 can enumerate potential disease(s) and/or other condition(s) for which the patient 110 is at risk based on the digital twin 130. The digital twin 130 can be used to simulate, predict, and/or otherwise the patient's 110 risk, and that risk can be stored as the risk profile 1302. For example, based on weight, blood pressure, eating habit information, and/or other behavioral information stored in the digital twin 130, the patient's 110 risk for developing diabetes can be modeled and quantified in the risk profile 1302. As another example, the patient's 110 prior ligament history, age, and social history of playing basketball from the digital twin 130 can be used to predict the patient's 110 risk of ligament injury.

The patient digital twin 130 and risk profile 1302 can be used with rules and analytics 1304 to drive health outcomes for the patient 110. For example, the digital twin 130 and/or associated system (e.g., an EMR system, RIS/PACS system, etc.) can be programmed with rules and/or analytics 1304 to leverage the information, modeling, etc., provided by the digital twin 130 to make a decision, inform a decision, and/or otherwise drive a health outcome for the patient 110 (and/or a population including the patient 110, etc.). For example, at block 1306, the rules and analytics 1304 can be applied to the patient digital twin 130 and associated risk profile 1302 to generate an automated diagnosis recommendation. At block 1308, the rules and analytics 1304 can be applied to the patient digital twin 130 and associated risk profile 1302 to generate specific recommended actions to be taken (e.g., by the patient 110 and/or healthcare practitioner, etc.). Thus, rules and analytics 1304 can be put around the patient digital twin 130 to model probabilities, risks, and likely outcomes for the patient 110. A computer-assisted diagnosis (CAD) 1306 and recommended course of action (e.g., care plan, etc.) can be generated for the patient 110 and/or healthcare practitioner (e.g., care team, primary physician, surgeon, nurse, etc.) to follow. The course of action can be customized for that particular patient 110 given the patient digital twin 130.

Thus, certain examples provide the creation, use, and storage of the patient digital twin 130. The patient digital twin 130 can be used with a plurality of application including electronic medical records, revenue cycle, scheduling, image analysis, etc. The patient digital twin 130 can be used to drive a workflow engine, rules engine, etc. The patient digital twin 130 can be used in conjunction with a data capture engine with digital devices (e.g., edge devices for a cloud network, etc.), Web applications, social media, etc. Knowledge sources such as medical, chemical, genetic, etc., can be leveraged with and/or incorporated into the digital twin 130, for example. A data ingestion engine can operate based on information in and/or missing from the patient digital twin 130, for example. The patient digital twin 130 can be used in conjunction with an analytics engine to drive health outcomes, for example. The patient digital twin 130 is “the system of record” about the patient 110. The patient digital twin 130 includes clinical, genetic, family history, financial, environmental, and social data associated with the patient 110, for example. The patient digital twin 130 can be used by artificial intelligence (e.g., machine learning, deep learning, etc.) and/or other algorithms expressing scientific and medical knowledge to help the patient 110 maximize his or her health.

The patient digital twin 130 thus improves existing modeling of patient information. The patient digital twin 130 provides a new, improved representation of patient information and construct for simulation of patient health outcomes. The patient digital twin 130 improves health information systems and analytics processors by providing such systems with a new twin or model for data retrieval, data update, modeling, simulation, prediction, etc., not previously available from a static table of patient data. The patient digital twin 130 helps solve the problem of static, disjointed patient data and lack of ties between patient information, medical knowledge, access to care, cost, social context, and personal choices for proactive patient care and improved health outcomes.

The patient digital twin 130 provides a new, beneficial representation improving patient records and interaction technology as well as a new, innovative data structure for patient information modeling. For example, the patient digital twin 130 serves as a data set driving artificial intelligence algorithms. Rather than merely providing a table or data record to be queried for a search result, the patient digital twin 130 provides a shared augmented reality experience for the patient 110 and his/her care providers, for example. The patient digital twin 130 serves as a data set to drive planning and delivery of care to the patient 110 by care professionals, for example. The patient digital twin 130 also facilitates communicating care instructions to the patient 110 and his/her care team, as well as modeling those instructions and monitoring their progress, for example.

Thus, patient information and medical knowledge can be digitized together and combined in the patient digital twin 130 to provide an infrastructure to examine and process the data in an organized way to make valid medical decisions. Additional data such as family history, social determinants of health, etc., can also be incorporated into the digital twin 130 and leveraged to diagnose and treat the patient 110, for example. When data flows into a healthcare system, data associated with the patient 110 can be represented through the patient digital twin 130, and the digital twin 130 can provide a mechanism for diagnosis and modeling without even seeing the actual patient 110, for example. Information can be taken from an ambulatory EMR, RIS, PACS, etc., and incorporated in the digital twin 130 to improve, update, etc., the model of the patient 110. At certain times (e.g., pre- and post-operation, pre-exam, etc.), medical knowledge can be applied to the patient digital twin 130, which has different behavior characteristics in different circumstances based on the patient's 110 condition, setting, etc. The patient digital twin 130 expresses a digital version of the patient 110 that forms the center point of a rules/algorithm-driven care management system combining digital patient knowledge, digital medical knowledge, and social knowledge to improve patient health outcomes.

In certain examples, the patient digital twin 130 forms a model that can be used with a transfer function to mathematically represent or model inputs to and outputs from the patient 110 (e.g., physical changes, mental changes, symptoms, etc., and resulting conditions, effects, etc.). The transfer function helps the digital twin 130 to generate and model patient 110 attributes and/or evaluation metrics, for example. In certain examples, variation can be modeled based on analytics, etc., and modeled variation can be used to evaluate possible health outcomes for the patient 110 via the patient digital twin 130.

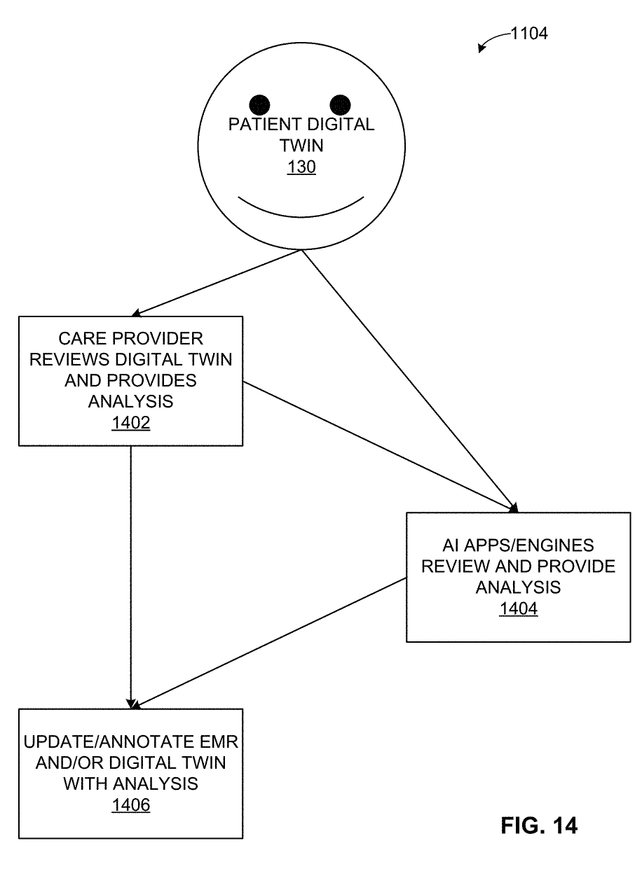

FIG. 14 illustrates an example implementation of block 1104 of FIG. 11 to leverage machine- and human-based diagnosis information to improve the patient digital twin 130. At block 1402, a care provider accesses the patient digital twin 130 and reviews the patient digital twin 130 to generate a care provider analysis. For example, the care provider can execute a simulation using the digital twin 130 and compare the results to known, expected, or reference results to determine their accuracy. The care provider can compare modeled information from the patient digital twin 130 with known information for the patient 110 and/or reference/“gold standard” information for patients similar to the patient 110, for example.

At block 1404, machine learning (e.g., artificial intelligence application(s), engine(s), such as deep learning, neural network, etc.) access and review the patient digital twin 130 to generate a machine learning analysis. For example, the machine learning processor can execute a simulation using the digital twin 130 and compare the results to known, expected, or reference results to determine their accuracy. The machine learning processor can compare modeled information from the patient digital twin 130 with known information for the patient 110 and/or reference/“gold standard” information for patients similar to the patient 110, for example. The machine learning processor can compare the patient digital twin 130 to other learned input to discover whether the patient digital twin 130 leads to an expected output. Feedback can be used to modify the patient digital twin 130 and/or adjust the machine learning network, for example.

At block 1406, the care provider and machine learning analyses are provided to update and/or otherwise annotate an EMR and/or the patient digital twin 130. For example, output analysis from the care provider and/or the machine learning processor can be used to update the patient's 110 medical record at an EMR and/or to correct, modify, improve, etc., the patient digital twin 130. Thus, the patient digital twin 130 receives feedback to continue to correct, tweak, improve, and/or otherwise adjust the patient model and its probabilistic, predictive, simulation ability, for example.

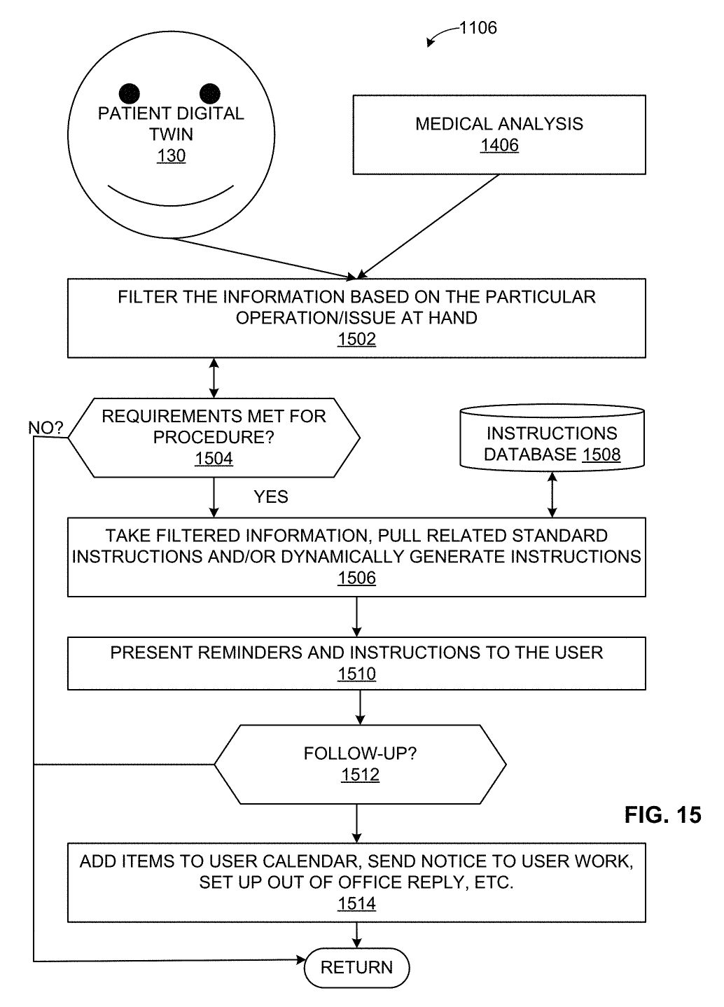

FIG. 15 illustrates an example implementation of block 1106 of FIG. 11 to learn from user experience. The patient digital twin 130 and medical analysis from block 1406 are provided, and, at block 1502, the received digital twin 130 and medical analysis 1406 information is filtered based on a particular operation and/or other issue at hand. For example, a particular target organ, relevant test data, analysis facts, risk facts, etc., can be used to filter the input digital twin 130 and associated analysis 1406 information.

At block 1504, the filtered information is reviewed to determine whether the requirements have been met for a procedure associated with the particular operation/issue. If requirements have not been met, then the information is insufficient for further action and/or feedback, and the process ends. If requirements have been met, then, at block 1506, “standard” or default instructions are pulled from an instructions database 1508 based on the filtered information. Alternatively or in addition, instructions can be dynamically generated for a specific case based on the filtered information.

At block 1510, reminders and instructions are presented to a user based on the filtered information and instructions from block 1506. At block 1512, follow-up is evaluated. If no follow-up is to be conducted, then the process ends. If follow-up is to be conducted, then, at block 1514, one or more follow-up items can be generated. For example, an item can be added to a user calendar. As another example, a notice can be sent to a user's workplace. An out-of-office reply can be set up for an appointment with the user, for example.

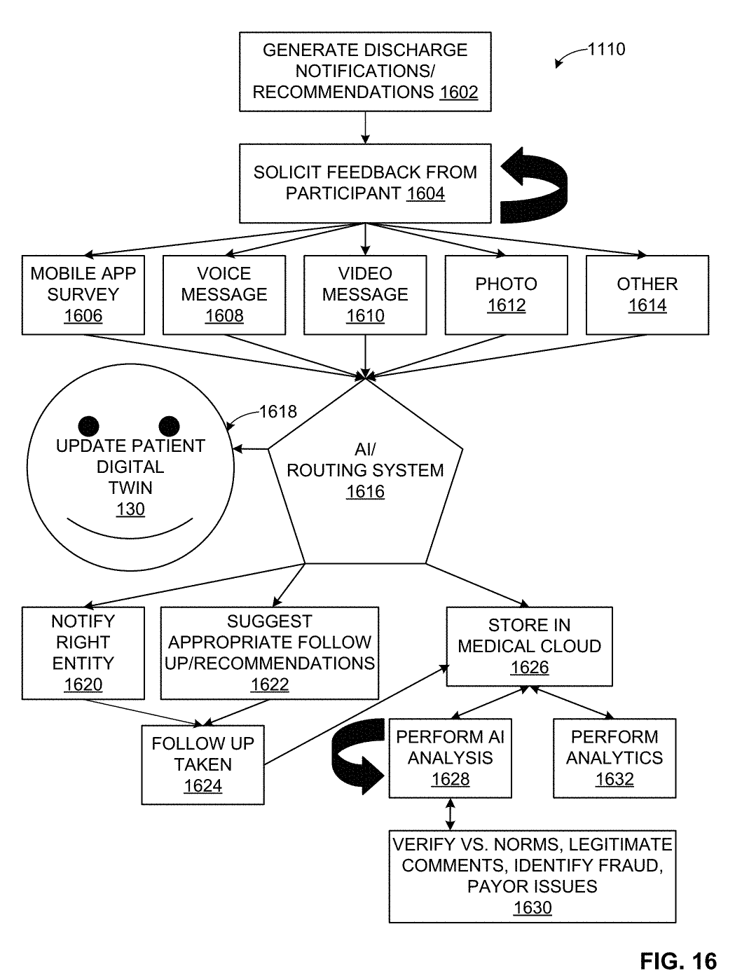

FIG. 16 illustrates an example implementation of block 1110 of FIG. 11 to generate, receive, and incorporate post-operative feedback to the patient digital twin 130, electronic medical record, etc. At block 1602, discharge notifications/recommendations are generated. For example, medication information (e.g., prescription, dosage, etc.), exercise regime (e.g., stretches, cardio, weights, etc.), clinician follow-up, etc., can be generated for the patient 110. At block 1604, feedback is solicited from a participant (e.g., the patient 110, clinician, etc.). Feedback can be submitted in a loop periodically such as every twenty-four hours, every seventy-two hours, once a week, etc. Feedback can be generated by one or more of a mobile application survey 1606 (e.g., smartphone app, tablet app, social media questionnaire, other electronic survey, etc.) to be completed by the participant, a voice message 1608 (e.g., a voicemail asking the participant to enter and/or call back with feedback, etc.), a video message 1610 (e.g., a video message asking the participant to visit a website, application, etc., and/or contact the sender with feedback, etc.), photo 1612 (e.g., asking the participant to take and send a photograph showing feedback, etc.), and/or other feedback 1614. Feedback can be obtained in detailed alphanumeric form and/or in brief graphical form (e.g., thumbs up/down, smiley face/frown/grimace/neutral, etc.), for example.

At block 1616, an artificial intelligence (AI)/routing system receives the feedback 1606-1614. The AI/routing system updates, at block 1618, the patient digital twin 130 using the feedback 1606-1614, for example. The patient/digital twin 130 can also be update using the discharge instructions, for example. The AI/routing system processes the feedback, discharge instructions, and/or other information and generates one or more follow-up actions in addition to updating the patient digital twin 130.

For example, at block 1620, an appropriate entity is notified of the feedback 1606-1614. For example, an electronic mail, instant message, and/or text message, etc., can be sent to a clinician associated with the participant who can respond to the feedback 1606-1614 (e.g., by checking the patient 110, updating a record, adjusting the discharge instructions, etc.). At block 1622, a follow-up and/or other recommendation is suggested. For example, a next action is suggested in response to the feedback 1606-1614. For example, a recommendation for a follow-up appointment with the patient 110 can be suggested, a change in discharge instruction can be suggested, etc. At block 1624, the follow-up is executed. For example, discharge instructions are changed and sent to the patient 110, a follow-up appointment is scheduled with the patient 110, etc. At block 1626, the follow-up and/or other information from the AI/routing system is stored in a medical cloud. For example, an EMR and/or the patient digital twin 130 implemented in a cloud-based environment can receive and store information to be made available to a variety of processes, systems, users, etc.

At block 1628, an AI analysis is performed on the information stored in the cloud. For example, care providers, procedure information, other diagnosis and/or treatment information, discharge instructions, follow-up actions/recommendations, etc., can be processed using the AI (e.g., machine learning, deep learning, etc.). At block 1630, the AI analysis can be used to verify information with respect to normal values/recommendations, legitimate comments/feedback, fraud identification, payor issues, etc. At block 1632, analytics can also be performed on the data. Such analytics can be fed back into the EMR and/or patient digital twin 130, for example.

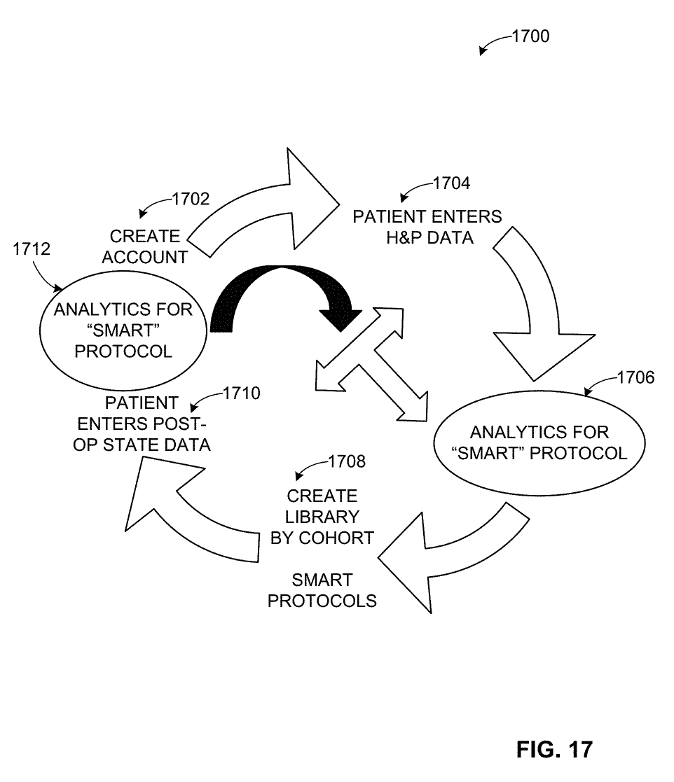

FIG. 17 illustrates an example process 1700 using an evidence-based patient digital twin 130 for improved care planning and outcomes. At 1702, an account is created for the patient 110. For example, the patient 110 can create an account with an EMR, EHR, PHMS, etc., and/or a clinician can create an account for the patient 110 on his or her behalf. For example, the patient 110 creates a “mysurgeryassist” account based on a link sent from the surgeon's office, etc. The patient 110 may receive a link to access and set up the account, for example. The account can be linked with and/or incorporated into the patient digital twin 130, for example.

For example, post-surgery patient follow-up is often inadequate and inefficient. Through the patient digital twin 130, a cost of collecting information can be lowered to provide for more pertinent information, sooner, and more frequently. Phone calls can be replaced by automatic data collection, and post-operative patients, for example, can be automatically triaged to identify patients who are doing fine and patients who should be contacted via a graphical user interface (GUI) associated with the patient digital twin 130 and the post-operative application forming part of the digital twin 130, for example.

At 1704, the patient 110 enters history and physical examination data. For example, the patient 110 enters information regarding his or her history, past physical examinations, current health state data, etc., via an EMR, EHR, etc. Alternatively or in addition, a clinician can enter history and physical examination data (e.g., patient medical history) on the patient's behalf. Thus, the patient's 110 history and exam findings at time of admission can be encoded in a patient account (and, therefore, the digital twin 130), for example. Information can be entered based on healthcare protocol, upcoming procedure, particular patient, etc. The data is saved for retrieval and evaluation by care provider(s) (e.g., via the patient digital twin 130, etc.).

At 1706, analytics for a “smart” protocol are generated based on the patient's medical data (e.g., as reflected in the patient digital twin 130). For example, patient medical data from the digital twin 130 along with validation information from a care provider determines pre-operative testing requirements for safe patient surgical intervention (e.g., surgeon/anesthesia clearance that the patient 110 meets acceptable criteria for surgery and anesthesia, etc.). Such pre-operative testing requirements can be formulated as a “smart” protocol to be applied by or with respect to the patient digital twin 130, for example. A pre-operative (pre-op) smart protocol can identify lab(s), imaging, patient education, and/or other pre-op task(s) to be executed by the patient 110 and/or provider(s) prior to a procedure, for example. The smart protocol can guide the patient 110 and/or provider(s) through pre-op task(s) and compare digital twin 130 modeling for likely outcome to actual pre-op information, for example.

At 1708, a library of smart protocols is created by cohort. For example, as a data warehouse is populated, identified cohorts can be used to create “smart” pre-surgical protocols to standardize care plans and improve outcomes and perhaps decrease costs. Provider users can build and select “evidence based” protocols from the library to help reduce unnecessary testing and assure required testing is completed, for example. One or more protocols can be selected (e.g., by provider, automatically via the patient digital twin 130, etc.) for the patient 110 based on procedure, patient type, other condition, etc.

At 1710, after the procedure has been performed, the patient 110 enters post-operative medical state data. For example, elements of post-surgical data are entered at specific time intervals to follow the patient 110 between discharge from the hospital (and/or other healthcare facility) and a first post-operative (post-op) visit with the surgeon. The post-op data provides status information such as pain, mobility, intake/output, incision site, etc. Post-op data fed into the patient digital twin 130 helps to facilitate documented immediate post-op follow up as well as identify risks very early and have an ability to follow-up with the patient 110 before the first post-op visit (e.g., preventative measures, etc.).

At 1712, “smart” cohort/evidence based protocols are created for post-op care. Post-op smart protocol analytics help to improve identification and follow-up of at-risk post-op patients as well as impact pre-op smart protocols in anticipation of post-op follow-up. For example, post-op protocols can drive the patient digital twin 130 and/or clinical system to arrange and/or otherwise monitor post-op visit(s), feedback intervals (e.g., 24-hour status update, 72-hour status update, 7-day status update, etc.) for one or more criteria (e.g., pain, nausea/vomiting, incision status, mobility/activity, fluid/diet tolerance, sleep/general comfort, etc.), etc.

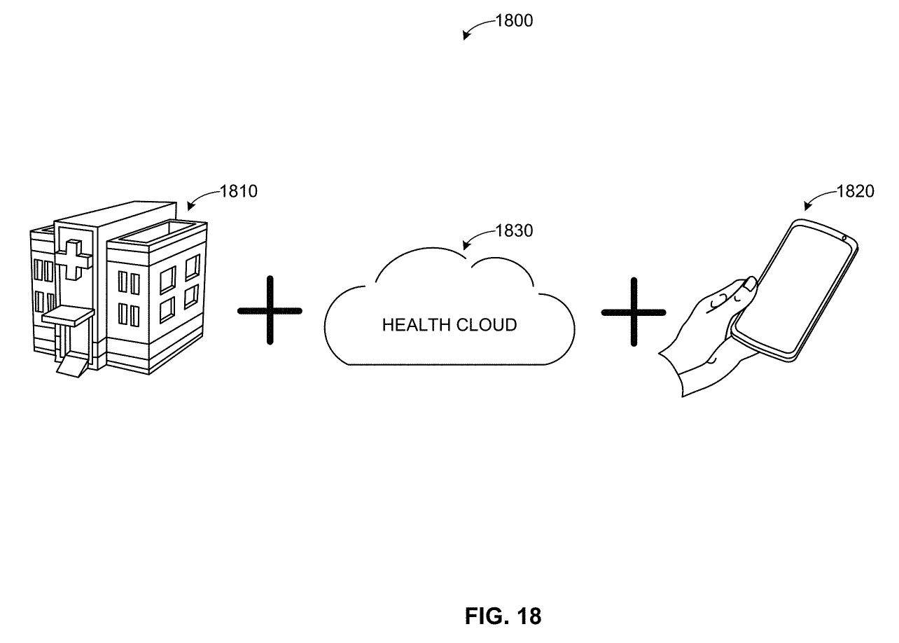

Thus, as illustrated in the example ecosystem 1800 of FIG. 18, a healthcare facility 1810 and a mobile device 1820 can work together via a health cloud 1830 to facilitate trending and tracking of the patient's 110 post-operative follow-up records via the patient digital twin 130. The patient digital twin 130 can be stored at the healthcare facility 1810 and/or the health cloud 1830, for example, and can interact with a post-op survey provided via the mobile device 1820 (e.g., a cellular phone, a tablet computer, a laptop computer, etc.). The patient digital twin 130 can model patient 110 behavior after surgery, for example, and additional information provided by the patient 110 (e.g., via survey and/or other application at the mobile device 1820, etc.) to predict whether intervention with the patient 110 before the patient's scheduled post-op appointment should be triggered. Early intervention with a post-op patient 110 can help to prevent hospital readmission and/or other health-threatening complication to the patient 110. Post-op feedback can also help to improve the patient digital twin 130, as insight into how the patient 110 handles pain medication, physical therapy, and/or other procedure follow-up can help improve the accuracy of the patient digital twin 130 in modeling patient 110 behavior, for example. Alphanumeric data, voice response, video input, image data, etc., can provide a multi-media model of the patient 110 via the patient digital twin 130, for example.

Whereas the patient 110 may be reluctant to complain of issues or unwilling to contact a provider for follow-up, the patient digital twin 130 can alert the provider to likely issues based on patient 110 information, reference/normal/standard information, and information from the provider regarding the circumstances of the patient's operation, for example. While a post-surgery follow-up appointment may not be scheduled until a week after surgery, for example, the patient digital twin 130 (e.g., with or without patient 110 survey feedback, etc.) can identify a likely problem on day 3, for example, rather than waiting for the problem to worsen by day 7. Rather than defensive medicine, electronic collection of post-op data and modeling of that data (e.g., via machine learning, etc.) using the digital twin 130 can provide proactive patient care. Matching post-op data to pre-op information and patient history, the patient digital twin 130 can identify potential problems for recovery and develop or enhance smart protocols for recovery crafted for the particular patient 110, for example. The patient digital twin 130 continues to learn and improve as it receives and models feedback throughout the pre-procedure, during procedure, and post-procedure process.

In certain examples, improved modeling of the patient 110 via the patient digital twin 130 can reduce or avoid pre-op visits as well. Instead, pre-op instructions and likely outcomes can be provided via the patient digital twin 130, and the patient 110 may be asked to schedule an in-person pre-op appointment when the digital twin 130 predicts a probability (e.g., higher than a threshold of concern, etc.) of complication, patient non-compliance, etc. Through digital twin 130 modeling, simulation, prediction, etc., information can be communicated to patient 110 and provider to improve adherence to pre- and post-op instructions and outcomes, for example.

Feedback and modeling via the digital twin 130 can also impact the care provider. For example, a surgeon's preference cards can be updated/customized for the particular patient 110 based on the patient's digital twin 130. Implants, such as knee, pacemaker, stent, etc., can be modeled for the benefit of the patient 110 and the provider via the digital twin 130, for example. Instruments and/or other equipment used in procedures can be modeled, tracked, etc., with respect to the patient 110 and the patient's procedure via the digital twin 130, for example. Alternatively or in addition, parameters, settings, and/or other configuration information can be pre-determined for the patient 110 and a particular procedure based on modeling via the patient digital twin 130, for example. Prescription(s), laboratory test(s), referral(s), etc., can be driven via the patient digital twin 130, alone or in conjunction with patient 110 and/or provider feedback, for example. In certain examples, the patient 110 can video chat with a provider and the digital twin 130 can facilitate a discussion of issue(s), instruction(s), etc. In certain examples, data mining, modeling, prediction, other probabilities, etc., generated for the particular patient 110 via the patient digital twin 130 can be extrapolated (and anonymized) for an associated or similar population (e.g., via a PHMS, etc.). Thus, one patient's 110 experience can help to improve health care experiences for a plurality of similar patients (e.g., by relation, geographic area, body type, condition, employment, race, gender, etc.).

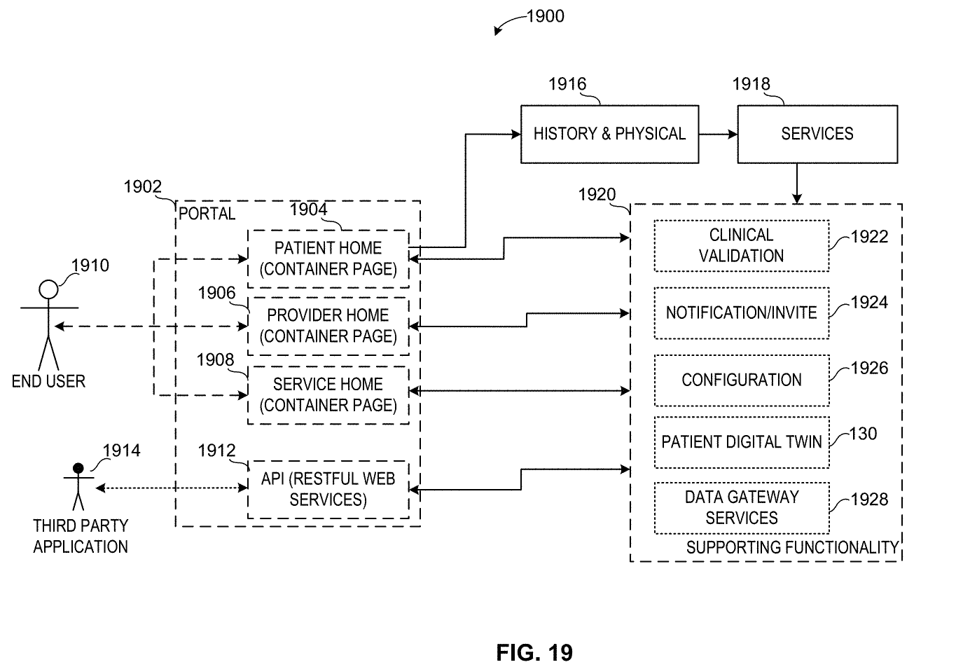

FIG. 19 illustrates an example architecture 1900, accessible via a portal 1902 at a computer at the healthcare facility 1810 and/or at the mobile device 1820. The example portal 1902 includes a patient home 1904, a provider home 1906, a service home 1908 for a user 1910 (e.g., the patient 110, authorized family member, care provider, etc.), and an application programming interface (API) 1912 accessible by a third-party application 1914. In certain examples, the patient home 1904, provider home 1906, and/or service home 1908 can be implemented as container pages. In certain examples, the API 1912 can be implemented using RESTful Web services.

Via the patient home 1904, the patient 110 and/or authorized family member (e.g., parent, spouse, guardian, etc.) can access patient history and physical information 1916, which is provided to patient services 1918 (e.g., appointment scheduling, electronic medical records, etc.). The patient services 1918 provide input into supporting functionality 1920 including clinical validation 1922, notification/invitation 1924, configuration 1926, data gateway services 1928, and/or the patient digital twin 130, for example. The patient home 1904 can also provide access to the supporting functionality 1920, such as the clinical validation 1922, patient digital twin 130, etc., without going through H&P 1916 and services 1918, for example. The provider home 1906 provides access to the supporting functionality 1920 such as clinical validation 1922, notification/invitation 1924, configuration 1926, patient digital twin 130, etc. The services home 1908 provides access to the supporting functionality 1920 such as configuration 1926, patient digital twin 130, etc. The API 1912 provides access to the supporting functionality 1920 including data gateway services 1928, patient digital twin 130, etc.

Thus, using the example architecture 1900, which can be housed at the healthcare facility 1810, the health cloud 1830, etc., the patient digital twin 130 can be updated based on user and/or application feedback, accessed by the patient 110, provider, other application, etc., and leveraged with services 1918 such as pre-op services, operational services, post-op services, etc., for the patient 110, a group of patients, etc. Feedback and/or additional information provided by the patient 110, authorized family member, care provider, third party application 1914, etc., can be input to the patient digital twin 130 and/or other model, application, database, etc., to improve patient 110 diagnosis and feedback including pre-procedure preparation, procedure execution, post-procedure recovery and follow-up, etc. The patient digital twin 130 can improve its modeling, probabilistic and/or deterministic analysis, data accuracy, etc., through feedback, for example. An ongoing cycle of feedback improves the digital twin 130 for the patient 110, a patient population, an understanding of “normal” or “standard” behavior/response, etc., to provide better outcomes for patient and/or population health. In an example, the mobile device 1820 provides access to the portal 1902, which is located in the health cloud 1830, which provides access to the services 1918 and supporting functionality 1920, located on the health cloud 1830 and/or healthcare facility 1910.

Machine Learning Example

Machine learning techniques, whether deep learning networks or other experiential/observational learning system, can be used to model information in the digital twin 130 and/or leverage the patient digital twin 130 to analyze and/or predict a patient 110 outcome, for example. Deep learning is a subset of machine learning that uses a set of algorithms to model high-level abstractions in data using a deep graph with multiple processing layers including linear and non-linear transformations. While many machine learning systems are seeded with initial features and/or network weights to be modified through learning and updating of the machine learning network, a deep learning network trains itself to identify “good” features for analysis. Using a multilayered architecture, machines employing deep learning techniques can process raw data better than machines using conventional machine learning techniques. Examining data for groups of highly correlated values or distinctive themes is facilitated using different layers of evaluation or abstraction.

Deep learning is a class of machine learning techniques employing representation learning methods that allows a machine to be given raw data and determine the representations needed for data classification. Deep learning ascertains structure in data sets using backpropagation algorithms which are used to alter internal parameters (e.g., node weights) of the deep learning machine. Deep learning machines can utilize a variety of multilayer architectures and algorithms. While machine learning, for example, involves an identification of features to be used in training the network, deep learning processes raw data to identify features of interest without the external identification.

Deep learning in a neural network environment includes numerous interconnected nodes referred to as neurons. Input neurons, activated from an outside source, activate other neurons based on connections to those other neurons which are governed by the machine parameters. A neural network behaves in a certain manner based on its own parameters. Learning refines the machine parameters, and, by extension, the connections between neurons in the network, such that the neural network behaves in a desired manner.

Deep learning that utilizes a convolutional neural network (CNN) segments data using convolutional filters to locate and identify learned, observable features in the data. Each filter or layer of the CNN architecture transforms the input data to increase the selectivity and invariance of the data. This abstraction of the data allows the machine to focus on the features in the data it is attempting to classify and ignore irrelevant background information.

Alternatively or in addition to the CNN, a deep residual network can be used. In a deep residual network, a desired underlying mapping is explicitly defined in relation to stacked, non-linear internal layers of the network. Using feedforward neural networks, deep residual networks can include shortcut connections that skip over one or more internal layers to connect nodes. A deep residual network can be trained end-to-end by stochastic gradient descent (SGD) with backpropagation, such as described above.

Deep learning operates on the understanding that many datasets include high level features which include low level features. While examining an image, for example, rather than looking for an object, it is more efficient to look for edges which form motifs which form parts, which form the object being sought. These hierarchies of features can be found in many different forms of data such as speech and text, etc.

Learned observable features include objects and quantifiable regularities learned by the machine during supervised learning. A machine provided with a large set of well classified data is better equipped to distinguish and extract the features pertinent to successful classification of new data.

A deep learning machine that utilizes transfer learning may properly connect data features to certain classifications affirmed by a human expert. Conversely, the same machine can, when informed of an incorrect classification by a human expert, update the parameters for classification. Settings and/or other configuration information, for example, can be guided by learned use of settings and/or other configuration information, and, as a system is used more (e.g., repeatedly and/or by multiple users), a number of variations and/or other possibilities for settings and/or other configuration information can be reduced for a given situation.

An example deep learning neural network can be trained on a set of expert classified data, for example. This set of data builds the first parameters for the neural network, and this would be the stage of supervised learning. During the stage of supervised learning, the neural network can be tested whether the desired behavior has been achieved.

Once a desired neural network behavior has been achieved (e.g., a machine has been trained to operate according to a specified threshold, etc.), the machine can be deployed for use (e.g., testing the machine with “real” data, etc.). During operation, neural network classifications can be confirmed or denied (e.g., by an expert user, expert system, reference database, etc.) to continue to improve neural network behavior. The example neural network is then in a state of transfer learning, as parameters for classification that determine neural network behavior are updated based on ongoing interactions. In certain examples, the neural network can provide direct feedback to another process. In certain examples, the neural network outputs data that is buffered (e.g., via the cloud, etc.) and validated before it is provided to another process.

Deep learning machines using convolutional neural networks (CNNs) can be used for data analysis. Stages of CNN analysis can be used for facial recognition in natural images, computer-aided diagnosis (CAD), etc.

Deep learning machines can provide computer aided detection support to improve image analysis, as well as computer aided diagnosis for the patient 110. Supervised deep learning can help reduce susceptibility to false classification, for example. Deep learning machines can utilize transfer learning when interacting with physicians to counteract the small dataset available in the supervised training. These deep learning machines can improve their computer aided diagnosis over time through training and transfer learning.

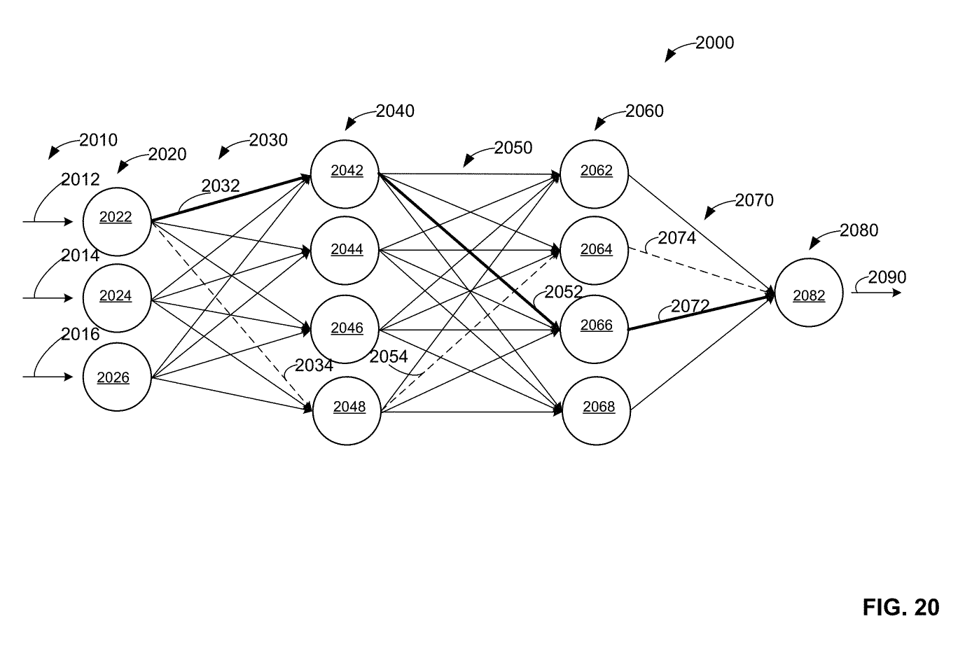

FIG. 20 is a representation of an example deep learning neural network 2000 that can be used to implement the patient digital twin 130. The example neural network 2000 includes layers 2020, 2040, 2060, and 2080. The layers 2020 and 2040 are connected with neural connections 2030. The layers 2040 and 2060 are connected with neural connections 2050. The layers 2060 and 2080 are connected with neural connections 2070. Data flows forward via inputs 2012, 2014, 2016 from the input layer 2020 to the output layer 2080 and to an output 2090.

The layer 2020 is an input layer that, in the example of FIG. 20, includes a plurality of nodes 2022, 2024, 2026. The layers 2040 and 2060 are hidden layers and include, the example of FIG. 20, nodes 2042, 2044, 2046, 2048, 2062, 2064, 2066, 2068. The neural network 2000 may include more or less hidden layers 2040 and 2060 than shown. The layer 2080 is an output layer and includes, in the example of FIG. 20, a node 2082 with an output 2090. Each input 2012-2016 corresponds to a node 2022-2026 of the input layer 2020, and each node 2022-2026 of the input layer 2020 has a connection 2030 to each node 2042-2048 of the hidden layer 2040. Each node 2042-2048 of the hidden layer 2040 has a connection 2050 to each node 2062-2068 of the hidden layer 2060. Each node 2062-2068 of the hidden layer 2060 has a connection 2070 to the output layer 2080. The output layer 2080 has an output 2090 to provide an output from the example neural network 2000.

Of connections 2030, 2050, and 2070 certain example connections 2032, 2052, 2072 may be given added weight while other example connections 2034, 2054, 2074 may be given less weight in the neural network 2000. Input nodes 2022-2026 are activated through receipt of input data via inputs 2012-2016, for example. Nodes 2042-2048 and 2062-2068 of hidden layers 2040 and 2060 are activated through the forward flow of data through the network 2000 via the connections 2030 and 2050, respectively. Node 2082 of the output layer 2080 is activated after data processed in hidden layers 2040 and 2060 is sent via connections 2070. When the output node 2082 of the output layer 2080 is activated, the node 2082 outputs an appropriate value based on processing accomplished in hidden layers 2040 and 2060 of the neural network 2000.

Example Healthcare Systems and Environments

Health information, also referred to as healthcare information and/or healthcare data, relates to information generated and/or used by a healthcare entity. Health information can be information associated with health of one or more patients, for example. Health information may include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient protected health information (PHI) between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure may include a centralized capability including, for example, a data repository, reporting, discrete data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. Example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, CCDA, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

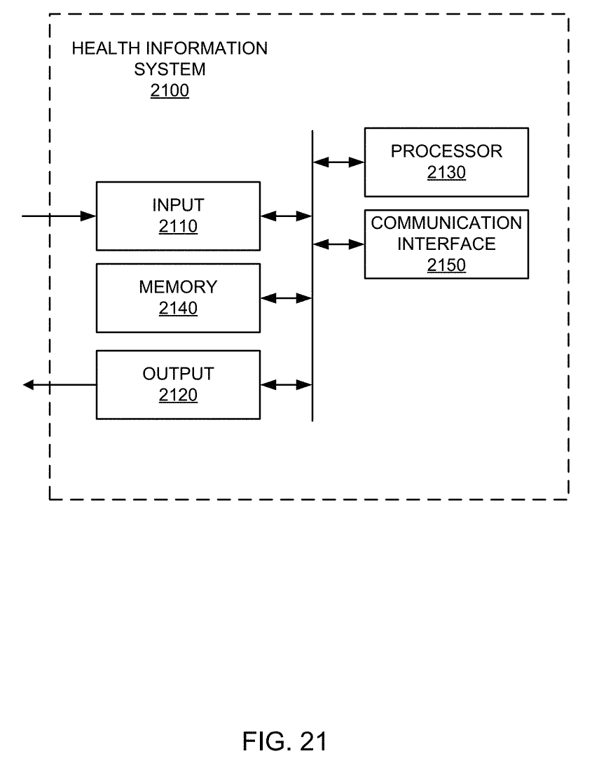

Turning now to the figures, FIG. 21 shows a block diagram of an example healthcare-focused information system 2100. Example system 2100 can be configured to implement a variety of systems (e.g., scheduler 1010, care system 1020, care ecosystem 1030, monitoring system 1040, portal 1902, services 1918, supporting functionality 1920, patient digital twin 130, etc.) and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), etc.

As illustrated in FIG. 21, the example information system 2100 includes an input 2110, an output 2120, a processor 2130, a memory 2140, and a communication interface 2150. The components of example system 2100 can be integrated in one device or distributed over two or more devices.

Example input 2110 may include a keyboard, a touch-screen, a mouse, a trackball, a track pad, optical barcode recognition, voice command, etc. or combination thereof used to communicate an instruction or data to system 2100. Example input 2110 may include an interface between systems, between user(s) and system 2100, etc.

Example output 2120 can provide a display generated by processor 2130 for visual illustration on a monitor or the like. The display can be in the form of a network interface or graphic user interface (GUI) to exchange data, instructions, or illustrations on a computing device via communication interface 2150, for example. Example output 2120 may include a monitor (e.g., liquid crystal display (LCD), plasma display, cathode ray tube (CRT), etc.), light emitting diodes (LEDs), a touch-screen, a printer, a speaker, or other conventional display device or combination thereof.

Example processor 2130 includes hardware and/or software configuring the hardware to execute one or more tasks and/or implement a particular system configuration. Example processor 2130 processes data received at input 2110 and generates a result that can be provided to one or more of output 2120, memory 2140, and communication interface 2150. For example, example processor 2130 can take user annotation provided via input 2110 with respect to an image displayed via output 2120 and can generate a report associated with the image based on the annotation. As another example, processor 2130 can process imaging protocol information obtained via input 2110 to provide an updated configuration for an imaging scanner via communication interface 2150.

Example memory 2140 can include a relational database, an object-oriented database, a Hadoop data construct repository, a data dictionary, a clinical data repository, a data warehouse, a data mart, a vendor neutral archive, an enterprise archive, etc. Example memory 2140 stores images, patient data, best practices, clinical knowledge, analytics, reports, etc. Example memory 2140 can store data and/or instructions for access by the processor 2130 (e.g., including the patient digital twin 130). In certain examples, memory 2140 can be accessible by an external system via the communication interface 2150.

Example communication interface 2150 facilitates transmission of electronic data within and/or among one or more systems. Communication via communication interface 2150 can be implemented using one or more protocols. In some examples, communication via communication interface 2150 occurs according to one or more standards (e.g., Digital Imaging and Communications in Medicine (DICOM), Health Level Seven (HL7), ANSI X12N, etc.), or proprietary systems. Example communication interface 2150 can be a wired interface (e.g., a data bus, a Universal Serial Bus (USB) connection, etc.) and/or a wireless interface (e.g., radio frequency, infrared (IR), near field communication (NFC), etc.). For example, communication interface 2150 may communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal or application programming interface (API), may be used to facilitate access to information, protocol library, imaging system configuration, patient care and/or practice management, etc. Information and/or functionality available via the Web-based portal may include one or more of order entry, laboratory test results review system, patient information, clinical decision support, medication management, scheduling, electronic mail and/or messaging, medical resources, etc. In certain examples, a browser-based interface can serve as a zero footprint, zero download, and/or other universal viewer for a client device.

In certain examples, the Web-based portal or API serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal or API may be accessible locally (e.g., in an office) and/or remotely (e.g., via the Internet and/or other private network or connection), for example. The Web-based portal may be configured to help or guide a user in accessing data and/or functions to facilitate patient care and practice management, for example. In certain examples, the Web-based portal may be configured according to certain rules, preferences and/or functions, for example. For example, a user may customize the Web portal according to particular desires, preferences and/or requirements.

Example Healthcare Infrastructure

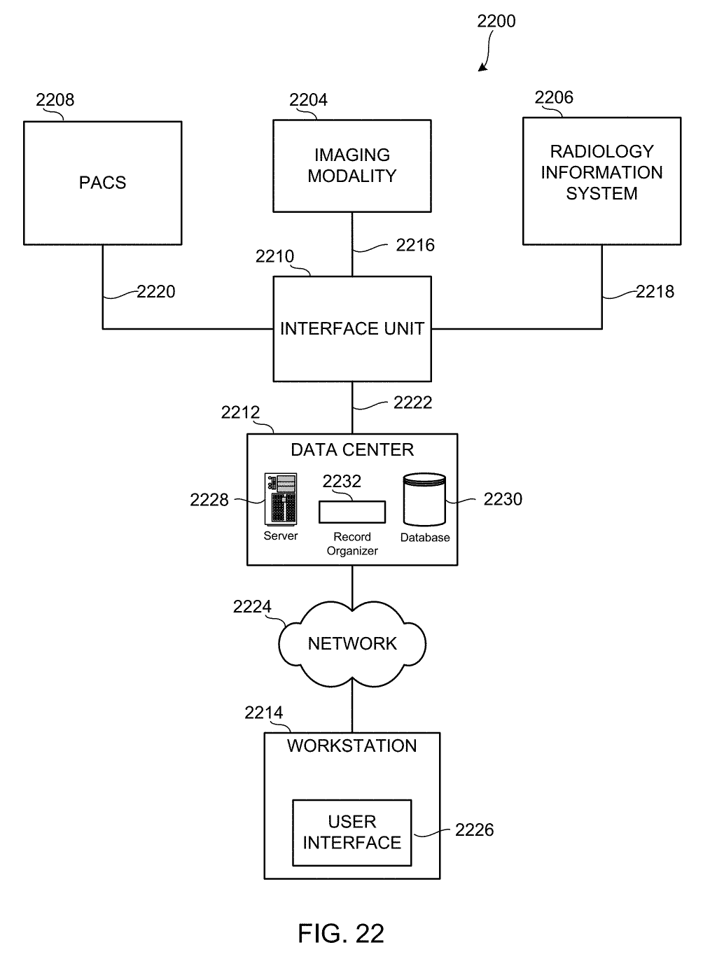

FIG. 22 shows a block diagram of an example healthcare information infrastructure 2200 including one or more subsystems (e.g., scheduler 1010, care system 1020, care ecosystem 1030, monitoring system 1040, portal 1902, services 1918, supporting functionality 1920, patient digital twin 130, etc.) such as the example healthcare-related information system 1500 illustrated in FIG. 15. Example healthcare system 2200 includes an imaging modality 2204, a RIS 2206, a PACS 2208, an interface unit 2210, a data center 2212, and a workstation 2214. In the illustrated example, scanner/modality 2204, RIS 2206, and PACS 2208 are housed in a healthcare facility and locally archived. However, in other implementations, imaging modality 2204, RIS 2206, and/or PACS 2208 may be housed within one or more other suitable locations. In certain implementations, one or more of PACS 2208, RIS 2206, modality 2204, etc., may be implemented remotely via a thin client and/or downloadable software solution. Furthermore, one or more components of the healthcare system 2200 can be combined and/or implemented together. For example, RIS 2206 and/or PACS 2208 can be integrated with the imaging scanner 2204; PACS 2208 can be integrated with RIS 2206; and/or the three example systems 2204, 2206, and/or 2208 can be integrated together. In other example implementations, healthcare system 2200 includes a subset of the illustrated systems 2204, 2206, and/or 2208. For example, healthcare system 2200 may include only one or two of the modality 2204, RIS 2206, and/or PACS 2208. Information (e.g., scheduling, test results, exam image data, observations, diagnosis, etc.) can be entered into the scanner 2204, RIS 2206, and/or PACS 2208 by healthcare practitioners (e.g., radiologists, physicians, and/or technicians) and/or administrators before and/or after patient examination. One or more of the imaging scanner 2204, RIS 2206, and/or PACS 2208 can communicate with equipment and system(s) in an operating room, patient room, etc., to track activity, correlate information, generate reports and/or next actions, and the like.

The RIS 2206 stores information such as, for example, radiology reports, radiology exam image data, messages, warnings, alerts, patient scheduling information, patient demographic data, patient tracking information, and/or physician and patient status monitors. Additionally, RIS 2206 enables exam order entry (e.g., ordering an x-ray of a patient) and image and film tracking (e.g., tracking identities of one or more people that have checked out a film). In some examples, information in RIS 2206 is formatted according to the HL-7 (Health Level Seven) clinical communication protocol. In certain examples, a medical exam distributor is located in RIS 2206 to facilitate distribution of radiology exams to a radiologist workload for review and management of the exam distribution by, for example, an administrator.

PACS 2208 stores medical images (e.g., x-rays, scans, three-dimensional renderings, etc.) as, for example, digital images in a database or registry. In some examples, the medical images are stored in PACS 2208 using the Digital Imaging and Communications in Medicine (DICOM) format. Images are stored in PACS 2208 by healthcare practitioners (e.g., imaging technicians, physicians, radiologists) after a medical imaging of a patient and/or are automatically transmitted from medical imaging devices to PACS 2208 for storage. In some examples, PACS 2208 can also include a display device and/or viewing workstation to enable a healthcare practitioner or provider to communicate with PACS 2208.

The interface unit 2210 includes a hospital information system interface connection 2216, a radiology information system interface connection 2218, a PACS interface connection 2220, and a data center interface connection 2222. Interface unit 2210 facilities communication among imaging modality 2204, RIS 2206, PACS 2208, and/or data center 2212. Interface connections 2216, 2218, 2220, and 2222 can be implemented by, for example, a Wide Area Network (WAN) such as a private network or the Internet. Accordingly, interface unit 2210 includes one or more communication components such as, for example, an Ethernet device, an asynchronous transfer mode (ATM) device, an 802.11 device, a DSL modem, a cable modem, a cellular modem, etc. In turn, the data center 2212 communicates with workstation 2214, via a network 2224, implemented at a plurality of locations (e.g., a hospital, clinic, doctor's office, other medical office, or terminal, etc.). Network 2224 is implemented by, for example, the Internet, an intranet, a private network, a wired or wireless Local Area Network, and/or a wired or wireless Wide Area Network. In some examples, interface unit 210 also includes a broker (e.g., a Mitra Imaging's PACS Broker) to allow medical information and medical images to be transmitted together and stored together.

Interface unit 2210 receives images, medical reports, administrative information, exam workload distribution information, and/or other clinical information from the information systems 2204, 2206, 2208 via the interface connections 2216, 2218, 2220. If necessary (e.g., when different formats of the received information are incompatible), interface unit 2210 translates or reformats (e.g., into Structured Query Language (“SQL”) or standard text) the medical information, such as medical reports, to be properly stored at data center 2212. The reformatted medical information can be transmitted using a transmission protocol to enable different medical information to share common identification elements, such as a patient name or social security number. Next, interface unit 2210 transmits the medical information to data center 2212 via data center interface connection 2222. Finally, medical information is stored in data center 2212 in, for example, the DICOM format, which enables medical images and corresponding medical information to be transmitted and stored together.

The medical information is later viewable and easily retrievable at workstation 2214 (e.g., by their common identification element, such as a patient name or record number). Workstation 2214 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. Workstation 2214 receives commands and/or other input from a user via, for example, a keyboard, mouse, track ball, microphone, etc. Workstation 2214 is capable of implementing a user interface 2226 to enable a healthcare practitioner and/or administrator to interact with healthcare system 2200. For example, in response to a request from a physician, user interface 2226 presents a patient medical history. In other examples, a radiologist is able to retrieve and manage a workload of exams distributed for review to the radiologist via user interface 2226. In further examples, an administrator reviews radiologist workloads, exam allocation, and/or operational statistics associated with the distribution of exams via user interface 2226. In some examples, the administrator adjusts one or more settings or outcomes via user interface 2226.

Example data center 2212 of FIG. 22 is an archive to store information such as images, data, medical reports, and/or, more generally, patient medical records. In addition, data center 2212 can also serve as a central conduit to information located at other sources such as, for example, local archives, hospital information systems/radiology information systems (e.g., HIS 2204 and/or RIS 2206), or medical imaging/storage systems (e.g., PACS 2208 and/or connected imaging modalities). That is, the data center 2212 can store links or indicators (e.g., identification numbers, patient names, or record numbers) to information. In the illustrated example, data center 2212 is managed by an application server provider (ASP) and is located in a centralized location that can be accessed by a plurality of systems and facilities (e.g., hospitals, clinics, doctor's offices, other medical offices, and/or terminals). In some examples, data center 2212 can be spatially distant from the imaging modality 2204, RIS 2206, and/or PACS 2208. In certain examples, the data center 2212 can be located in the cloud (e.g., on a cloud-based server, an edge device, etc.).

Example data center 2212 of FIG. 22 includes a server 2228, a database 2230, and a record organizer 2232. Server 2228 receives, processes, and conveys information to and from the components of healthcare system 2200. Database 2230 stores the medical information described herein and provides access thereto. Example record organizer 2232 of FIG. 22 manages patient medical histories, for example. Record organizer 2232 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray imaging protocol into the cloud-based clinical information system, and the second clinician may view and download the x-ray imaging protocol via a web browser and/or download the x-ray imaging protocol onto a local information system employed by the second clinician.

In certain examples, users (e.g., a patient and/or care provider) can access functionality provided by system 2200 via a software-as-a-service (SaaS) implementation over a cloud or other computer network, for example. In certain examples, all or part of system 2200 can also be provided via platform as a service (PaaS), infrastructure as a service (IaaS), etc. For example, system 2200 can be implemented as a cloud-delivered Mobile Computing Integration Platform as a Service. A set of consumer-facing Web-based, mobile, and/or other applications enable users to interact with the PaaS, for example.

Industrial Internet Examples

The Internet of things (also referred to as the “Industrial Internet”) relates to an interconnection between a device that can use an Internet connection to talk with other devices and/or applications on the network. Using the connection, devices can communicate to trigger events/actions (e.g., changing temperature, turning on/off, providing a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated.

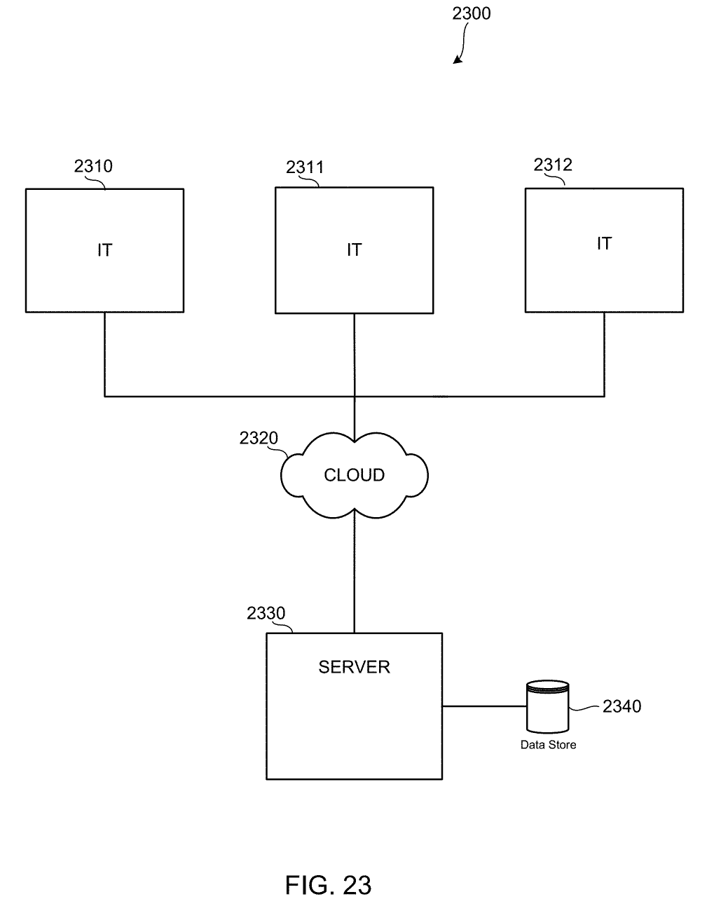

FIG. 23 illustrates an example industrial internet configuration 2300. Example configuration 2300 includes a plurality of health-focused systems 2310-2312, such as a plurality of health information systems 1500 (e.g., PACS, RIS, EMR, PHMS and/or other scheduler 1010, care system 1020, care ecosystem 1030, monitoring system 1040, services 1918, supporting functionality 1920, patient digital twin 130, etc.) communicating via industrial internet infrastructure 2300. Example industrial internet 2300 includes a plurality of health-related information systems 2310-2312 communicating via a cloud 2320 with a server 2330 and associated data store 2340.

As shown in the example of FIG. 23, a plurality of devices (e.g., information systems, imaging modalities, etc.) 2310-2312 can access a cloud 2320, which connects the devices 2310-2312 with a server 2330 and associated data store 2340. Information systems, for example, include communication interfaces to exchange information with server 2330 and data store 2340 via the cloud 2320. Other devices, such as medical imaging scanners, patient monitors, etc., can be outfitted with sensors and communication interfaces to enable them to communicate with each other and with the server 2330 via the cloud 2320.

Thus, machines 2310-2312 within system 2300 become “intelligent” as a network with advanced sensors, controls, analytical based decision support and hosting software applications. Using such an infrastructure, advanced analytics can be provided to associated data. The analytics combines physics-based analytics, predictive algorithms, automation, and deep domain expertise. Via cloud 2320, devices 2310-2312 and associated people can be connected to support more intelligent design, operations, maintenance, and higher server quality and safety, for example.

Using the industrial internet infrastructure, for example, a proprietary machine data stream can be extracted from a device 2310. Machine-based algorithms and data analysis are applied to the extracted data. Data visualization can be remote, centralized, etc. Data is then shared with authorized users, and any gathered and/or gleaned intelligence is fed back into the machines 2310-2312.

While progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance if appropriate industrial-specific data collection and modeling technology is developed and applied.

In an example, data from one or more sensors can be recorded or transmitted to a cloud-based or other remote computing environment. Insights gained through analysis of such data in a cloud-based computing environment can lead to enhanced asset designs, or to enhanced software algorithms for operating the same or similar asset at its edge, that is, at the extremes of its expected or available operating conditions. For example, sensors associated with the patient 110 can supplement the modeled information of the patient digital twin 130, which can be stored and/or otherwise instantiated in a cloud-based computing environment for access by a plurality of systems with respect to the patient 110.

Systems and methods described herein can include using a “cloud” or remote or distributed computing resource or service. The cloud can be used to receive, relay, transmit, store, analyze, or otherwise process information for or about the patient 110 and his/her digital twin 130, for example. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to patient monitoring, diagnosis, treatment, scheduling, etc., via the digital twin 130.

Data Mining Examples

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. Data mining can be used to help ensure patient safety, reduce disparity in treatment, provide clinical decision support, etc. Mining both structured and unstructured data from radiology reports, as well as actual image pixel data, can be used to tag and index both imaging reports and the associated images themselves. Data mining can be used to provide information to the patient digital twin 130, for example.

Example Methods of Use

Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, reviewing and reporting on an image, executing orders for specific care, signing off on orders for a discharge, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, radiology image reading, dispatching room cleaning and/or patient transport, and/or any other action useful in processing healthcare information or causing critical path care activities to progress. The defined clinical workflows may include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

In certain examples, a medical exam conducted on a patient can involve review by a healthcare practitioner, such as a radiologist, to obtain, for example, diagnostic information from the exam. In a hospital setting, medical exams can be ordered for a plurality of patients, all of which require review by an examining practitioner. Each exam has associated attributes, such as a modality, a part of the human body under exam, and/or an exam priority level related to a patient criticality level. Hospital administrators, in managing distribution of exams for review by practitioners, can consider the exam attributes as well as staff availability, staff credentials, and/or institutional factors such as service level agreements and/or overhead costs.

Additional workflows can be facilitated such as bill processing, revenue cycle mgmt., population health management, patient identity, consent management, etc.

While example implementations are illustrated in conjunction with FIGS. 1-17, elements, processes and/or devices illustrated in conjunction with FIGS. 1-17 may be combined, divided, re-arranged, omitted, eliminated and/or implemented in any other way. Further, components disclosed and described herein can be implemented by hardware, machine readable instructions, software, firmware and/or any combination of hardware, machine readable instructions, software and/or firmware. Thus, for example, components disclosed and described herein can be implemented by analog and/or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the components is/are hereby expressly defined to include a tangible computer readable storage device or storage disk such as a memory, a digital versatile disk (DVD), a compact disk (CD), a Blu-ray disk, etc. storing the software and/or firmware.

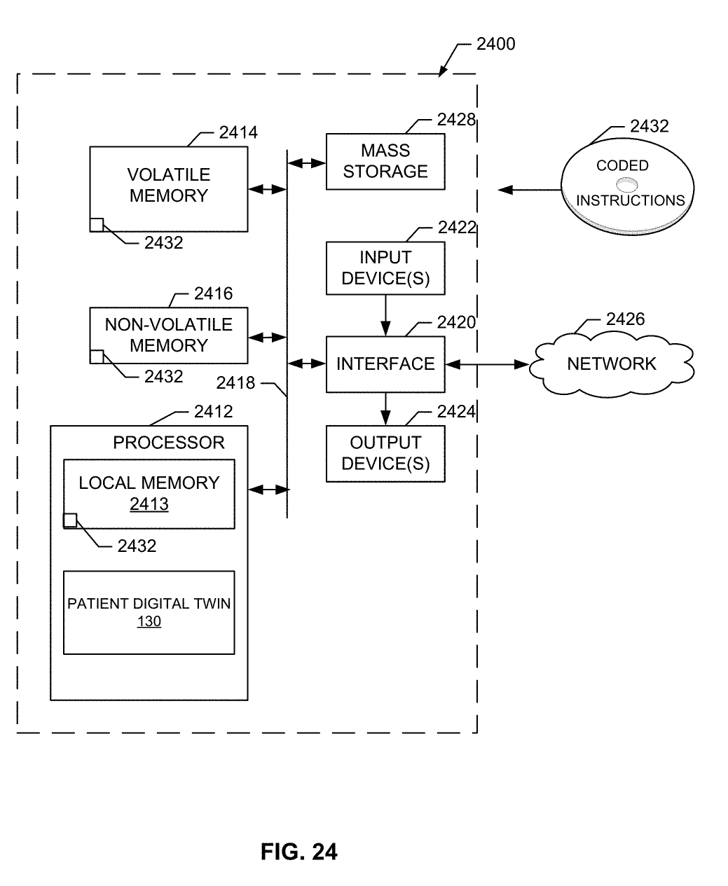

Flowcharts representative of example machine readable instructions for implementing components disclosed and described herein are shown in conjunction with FIGS. 9 and 11-17. In the examples, the machine readable instructions include a program for execution by a processor such as the processor 2412 shown in the example processor platform 1800 discussed below in connection with FIG. 24. The program may be embodied in machine readable instructions stored on a tangible computer readable storage medium such as a CD-ROM, a floppy disk, a hard drive, a digital versatile disk (DVD), a Blu-ray disk, or a memory associated with the processor 2412, but the entire program and/or parts thereof could alternatively be executed by a device other than the processor 2412 and/or embodied in firmware or dedicated hardware. Further, although the example program is described with reference to the flowcharts illustrated in conjunction with at least FIGS. 9 and 11-17, many other methods of implementing the components disclosed and described herein may alternatively be used. For example, the order of execution of the blocks may be changed, and/or some of the blocks described may be changed, eliminated, or combined. Although the flowcharts of at least FIGS. 9 and 11-17 depict example operations in an illustrated order, these operations are not exhaustive and are not limited to the illustrated order. In addition, various changes and modifications may be made by one skilled in the art within the spirit and scope of the disclosure. For example, blocks illustrated in the flowchart may be performed in an alternative order or may be performed in parallel.

As mentioned above, the example data structures and/or processes of at least FIGS. 1-17 can be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example data structures and processes of at least FIGS. 1-17 can be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. In addition, the term “including” is open-ended in the same manner as the term “comprising” is open-ended.

FIG. 24 is a block diagram of an example processor platform 2400 structured to executing the instructions of at least FIGS. 9 and 11-17 to implement the example components disclosed and described herein. The processor platform 2400 can be, for example, a server, a personal computer, a mobile device (e.g., a cell phone, a smart phone, a tablet such as an iPad™), a personal digital assistant (PDA), an Internet appliance, or any other type of computing device.

The processor platform 2400 of the illustrated example includes a processor 2412. The processor 2412 of the illustrated example is hardware. For example, the processor 2412 can be implemented by integrated circuits, logic circuits, microprocessors or controllers from any desired family or manufacturer.

The processor 2412 of the illustrated example includes a local memory 2413 (e.g., a cache). The example processor 2412 of FIG. 24 executes the instructions of at least FIGS. 9 and 11-17 to implement the patient digital twin 130 and associated scheduling system 1010, care system 1020, care ecosystem 1030, monitoring system 1040, portal 1902, services 1918, supporting functionality 1920, etc. The processor 2412 of the illustrated example is in communication with a main memory including a volatile memory 2414 and a non-volatile memory 2416 via a bus 2418. The volatile memory 2414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2416 may be implemented by flash memory and/or any other desired type of memory device. Access to the main memory 2414, 2416 is controlled by a clock controller.

The processor platform 2400 of the illustrated example also includes an interface circuit 2420. The interface circuit 2420 may be implemented by any type of interface standard, such as an Ethernet interface, a universal serial bus (USB), and/or a PCI express interface.

In the illustrated example, one or more input devices 2422 are connected to the interface circuit 2420. The input device(s) 2422 permit(s) a user to enter data and commands into the processor 2412. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 2424 are also connected to the interface circuit 2420 of the illustrated example. The output devices 2424 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 2420 of the illustrated example, thus, typically includes a graphics driver card, a graphics driver chip or a graphics driver processor.

The interface circuit 2420 of the illustrated example also includes a communication device such as a transmitter, a receiver, a transceiver, a modem and/or network interface card to facilitate exchange of data with external machines (e.g., computing devices of any kind) via a network 2426 (e.g., an Ethernet connection, a digital subscriber line (DSL), a telephone line, coaxial cable, a cellular telephone system, etc.).

The processor platform 2400 of the illustrated example also includes one or more mass storage devices 2428 for storing software and/or data. Examples of such mass storage devices 2428 include floppy disk drives, hard drive disks, compact disk drives, Blu-ray disk drives, RAID systems, and digital versatile disk (DVD) drives.

The coded instructions 2432 of FIG. 24 may be stored in the mass storage device 2428, in the volatile memory 2414, in the non-volatile memory 2416, and/or on a removable tangible computer readable storage medium such as a CD or DVD.

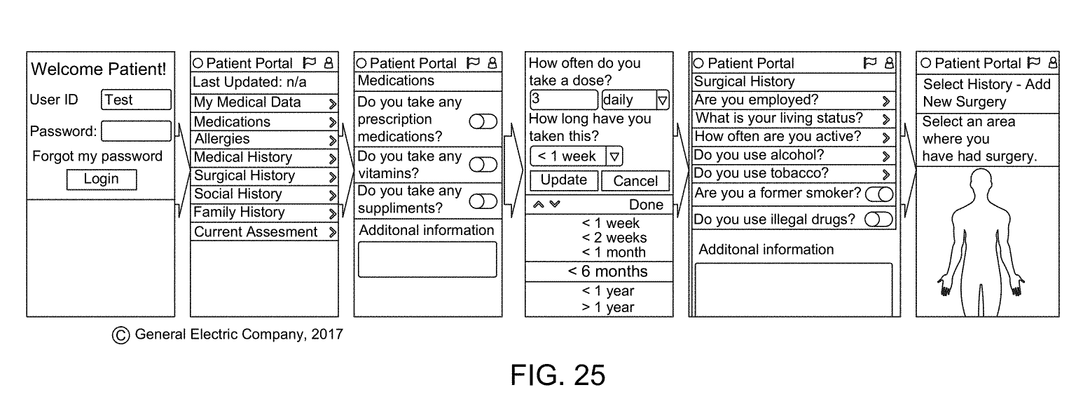

FIGS. 25-32 illustrate example graphical user interfaces (GUIs) to facilitate input and use of post-op and/or other feedback with respect to the patient digital twin 130 and/or other electronic medical record and/or clinical system. FIG. 25 illustrates an example workflow through a plurality of GUI screens of an example application for history and physical data collection. As shown in the example of FIG. 25, a user, such as the patient 110, etc., is guided through a series of interfaces (e.g., via the mobile device 1820, etc.) to gather feedback, such as post-op feedback, pre-op feedback, etc. The feedback and/or other input is routed through a patient portal to the patient digital twin 130 and/or other electronic medical record and/or clinical system, for example.

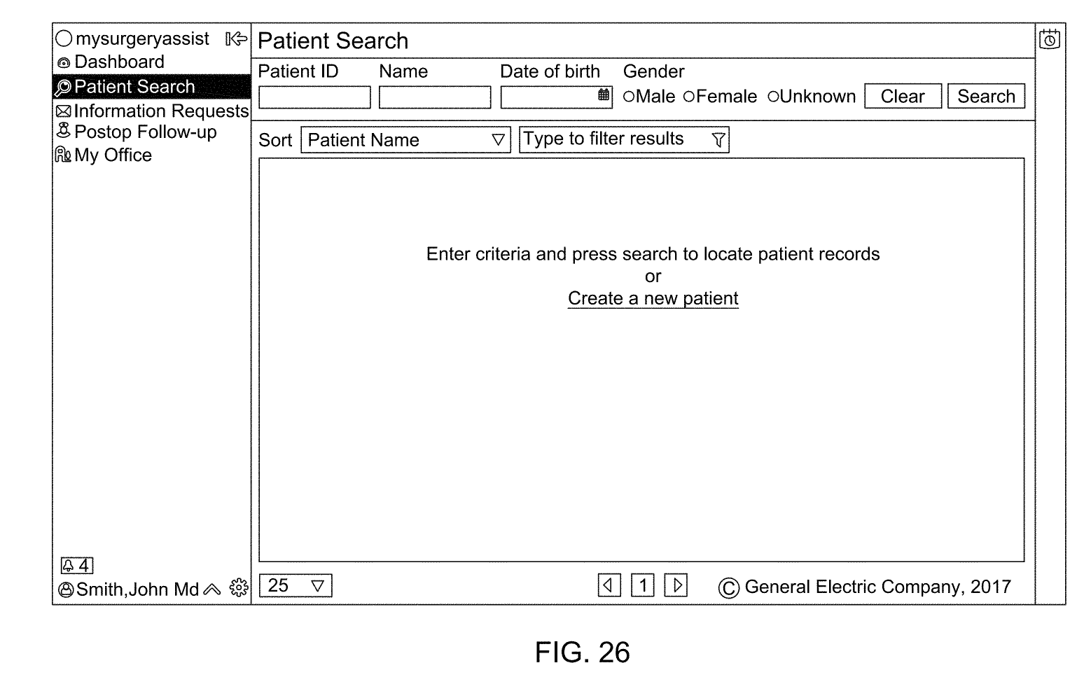

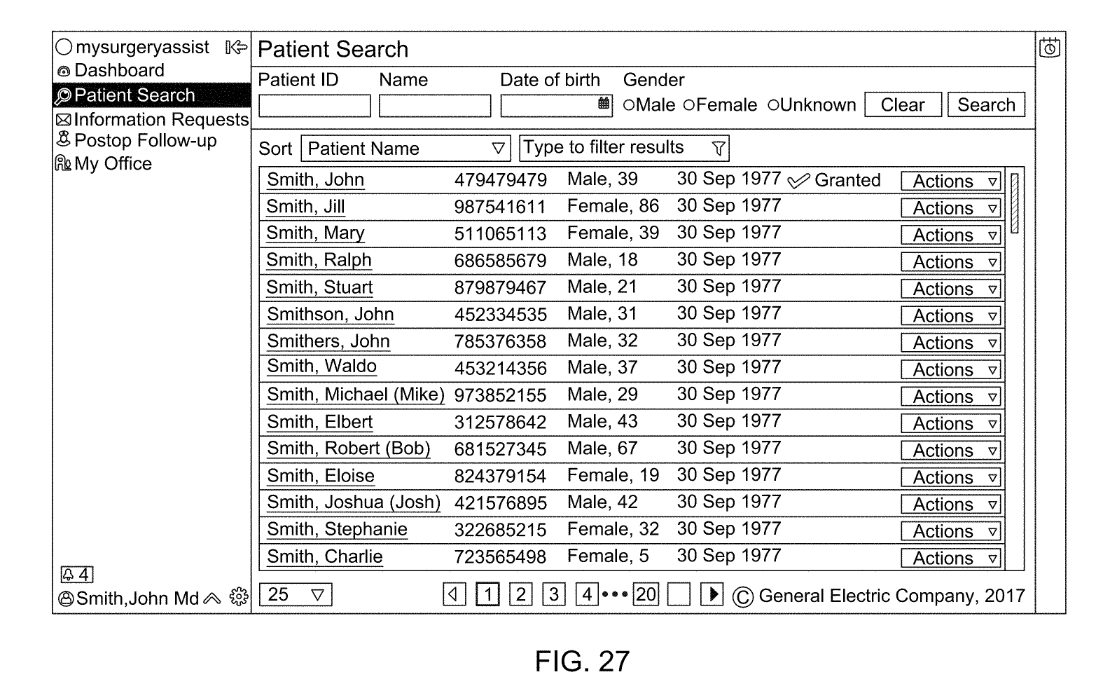

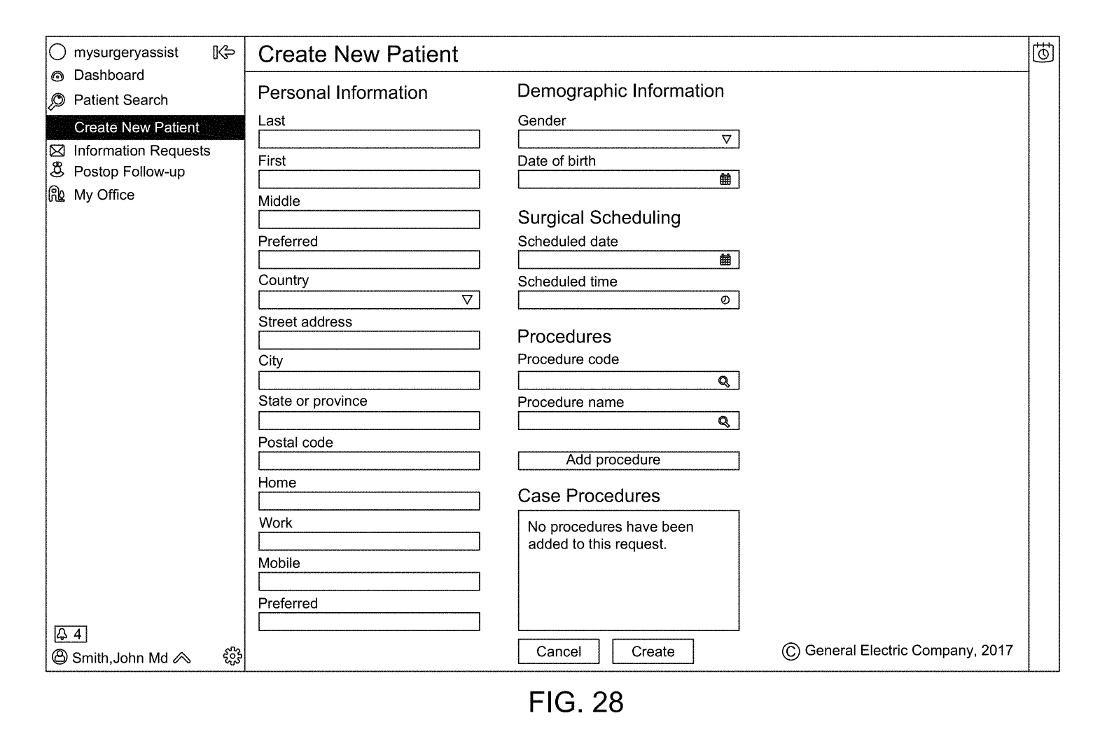

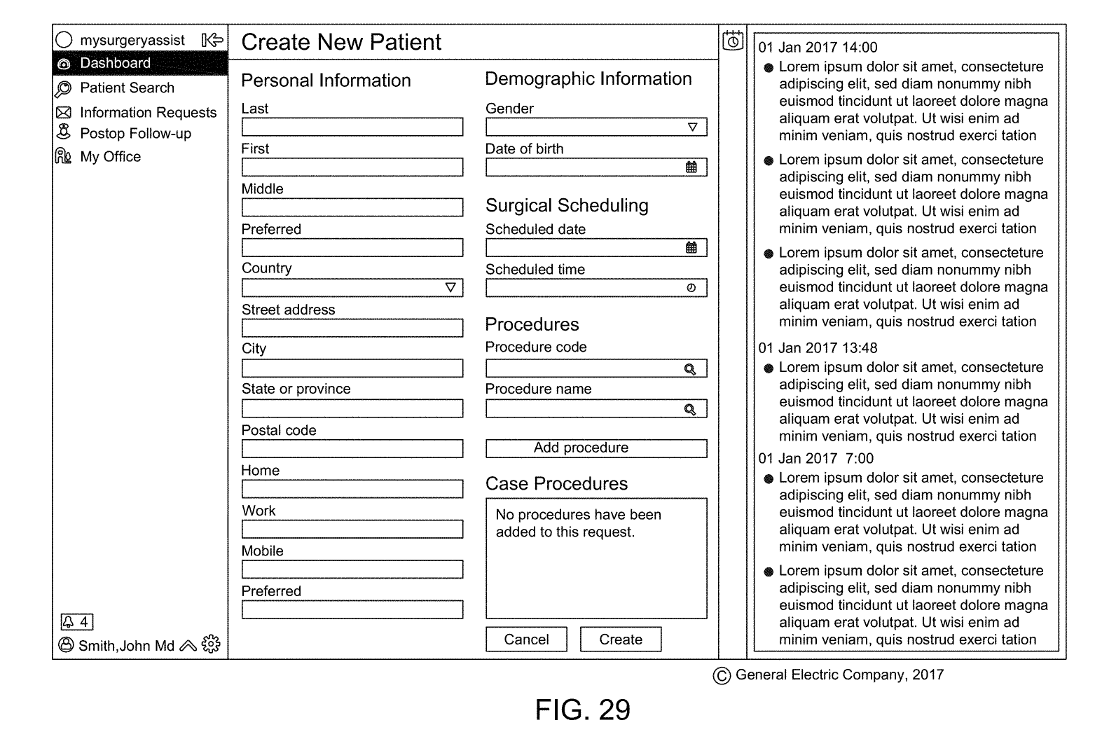

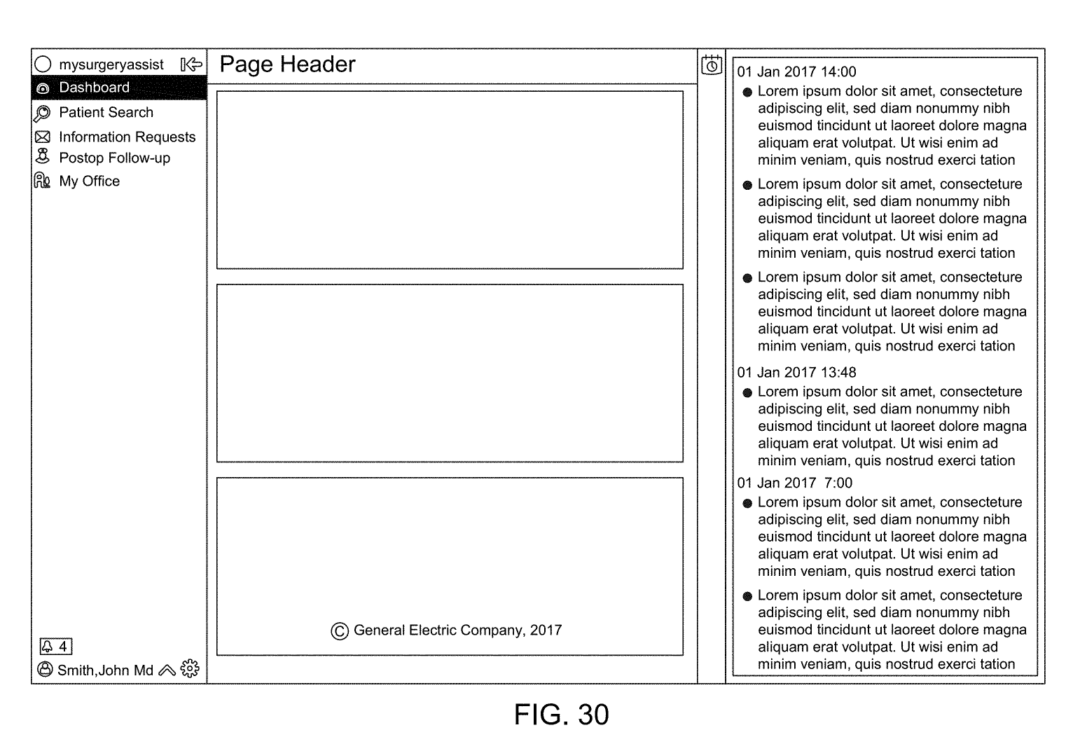

FIGS. 26-32 illustrate interface screens of an example provider-patient healthcare interface. FIG. 26 shows an example patient search screen to allow a user to search for a particular patient 110 and/or group of patients. FIG. 27 illustrates an example selectable list of patient search results. FIG. 28 shows an example interface to create a new patient record including personal information, demographic information, surgical scheduling, procedures, case procedures, etc., that can be shared and incorporated into the digital twin 130 as well as another electronic medical record, etc. FIG. 29 shows the new patient creation interface with a right panel expanded to show calendar and/or other note information, for example. FIG. 30 illustrates another patient dashboard interface with the right panel expanded and page header information expanded.

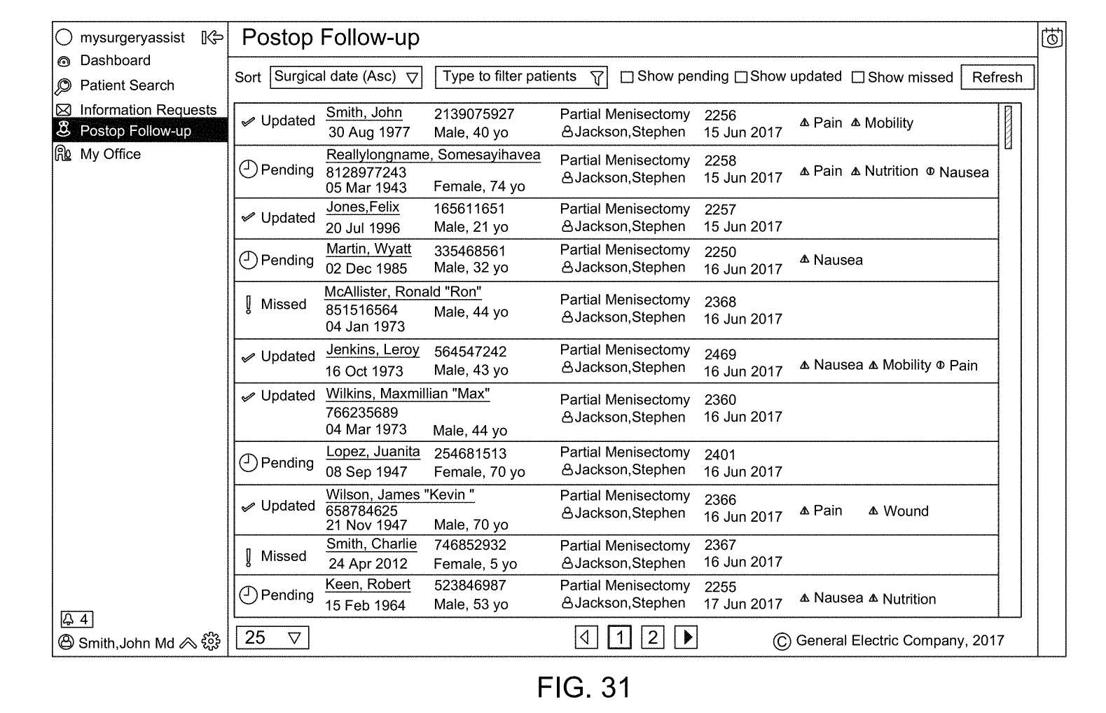

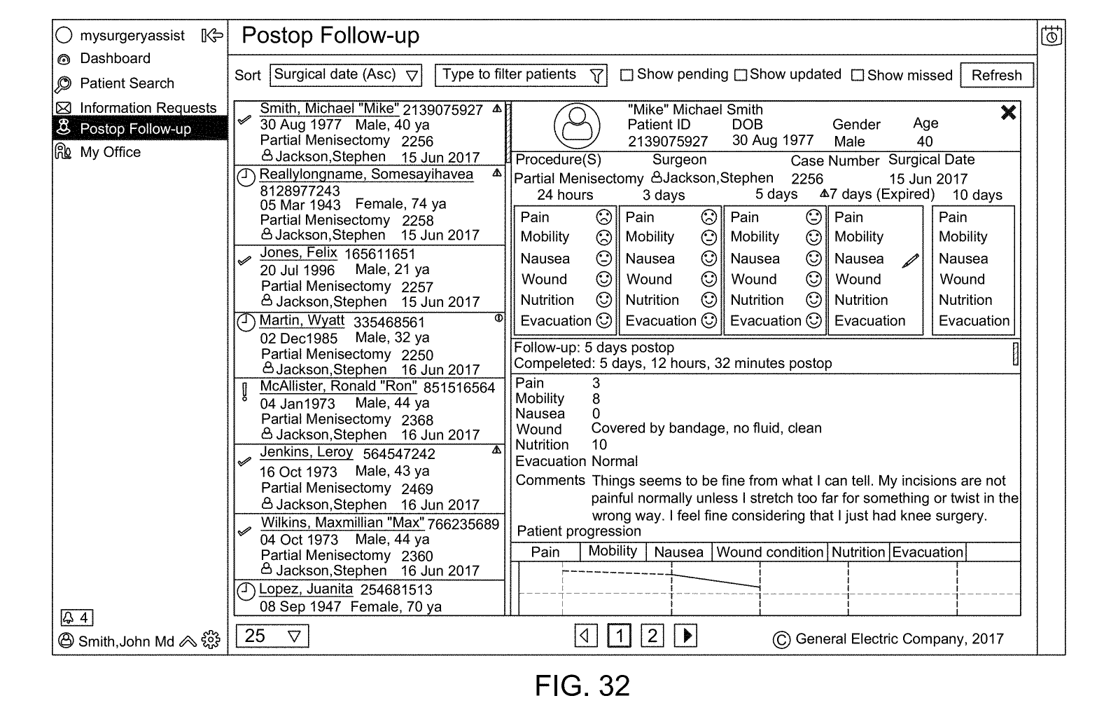

FIG. 31 shows an example list or set of post-op follow-up patients and associated tasks. Through the example interface of FIG. 31, a user can sort (e.g., by name, surgical date, surgery type, etc.) to identify patients with associated status (e.g., updated, pending, missed, etc.) and an indication of surgery (e.g., partial menisectomy, etc.) and surgeon. Issues such as pain, mobility, nausea, wound, nutrition, etc., can be shown and an icon, color, alphanumeric value, etc., can indicate a severity of such issue(s), for example. FIG. 32 illustrates an example post-op follow-up interface for a certain set of patients. A list of patients is shown on the left (e.g., organized according to follow-up status, name, etc.), and the right portion of the interface provides further detail regarding a selected patient. As shown in the example of FIG. 32, conditions experienced (e.g., pain, mobility, nausea, wound, nutrition, evacuation, etc.) can be rated or ranked (e.g., by alphanumeric value, graphical indication, etc.) at one or more times (e.g., at 24 hours, 3 days, 5 days, 7 days, 10 days, etc.). Follow-up and task completed information can also be provided via the interface, for example. A current indication of conditions/issues, such as pain, mobility, nausea, wound, nutrition, evacuation, and/or other comments, can be provided via the interface in addition to the time-based aggregate information, for example, and a progression of intensity values for each condition/issue can also be graphically displayed over time, for example.

From the foregoing, it will be appreciated that the above disclosed methods, apparatus, and articles of manufacture have been disclosed to create and dynamically update a patient digital twin that can be used in patient simulation, analysis, diagnosis, and treatment to improve patient health outcome.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. An apparatus comprising:
a processor and a memory, the processor to configure the memory according to a patient digital twin of a first patient, the patient digital twin including a data structure created from a combination of patient electronic medical record data and historical information, the combination extracted from one or more information systems and arranged in the data structure to form a digital representation of the first patient, the patient digital twin arranged for query and simulation via the processor,
the patient digital twin to receive feedback regarding the first patient following a procedure conducted on the first patient, the patient digital twin to incorporate the feedback into the patient digital twin when elements for the procedure have been completed, the patient digital twin to process the incorporated feedback to generate and output a recommendation for follow-up with respect to the first patient based on the digital representation of the first patient including the incorporated feedback with respect to the procedure conducted on the first patient.

2. The apparatus of claim 1, wherein the patient digital twin is to filter the feedback based on elements completed for the procedure to form the incorporated feedback.

3. The apparatus of claim 1, wherein the recommendation includes at least one of a reminder, an instruction, or a follow-up appointment.

4. The apparatus of claim 1, wherein the patient digital twin is to identify a post-operative issue for the first patient based on a comparison of the feedback to a reference value.

5. The apparatus of claim 4, wherein a follow-up appointment is to be triggered when the post-operative issue is identified.

6. The apparatus of claim 1, wherein the feedback is to be obtained using at least one of a mobile application survey, a voice message, a video message, or a photograph.

7. The apparatus of claim 1, wherein the incorporated feedback is to be processed using an artificial intelligence analysis to generate and output the recommendation.

8. The apparatus of claim 1, wherein the patient digital twin is to generate at least one of a pre-operative smart protocol to prepare the first patient for the procedure or a post-operative smart protocol to guide the patient after the procedure.

9. The apparatus of claim 1, wherein the patient digital twin is to interact with clinical services and supporting functionality including at least one of clinical validation, notification, configuration, or data gateway services.

10. A computer-readable storage medium comprising instructions which, when executed by a processor, cause a machine to implement at least:
a patient digital twin of a first patient, the patient digital twin including a data structure created from a combination of patient electronic medical record data and historical information, the combination extracted from one or more information systems and arranged in the data structure to form a digital representation of the first patient, the patient digital twin arranged for query and simulation via the processor,
the patient digital twin to receive feedback regarding the first patient following a procedure conducted on the first patient, the patient digital twin to incorporate the feedback into the patient digital twin when elements for the procedure have been completed, the patient digital twin to process the incorporated feedback to generate and output a recommendation for follow-up with respect to the first patient based on the digital representation of the first patient including the incorporated feedback with respect to the procedure conducted on the first patient.

11. The computer-readable storage medium of claim 10, wherein the patient digital twin is to filter the feedback based on elements completed for the procedure to form the incorporated feedback.

12. The computer-readable storage medium of claim 10, wherein the patient digital twin is to identify a post-operative issue for the first patient based on a comparison of the feedback to a reference value.

13. The computer-readable storage medium of claim 12, wherein a follow-up appointment is to be triggered when the post-operative issue is identified.

14. The computer-readable storage medium of claim 10, wherein the feedback is to be obtained using at least one of a mobile application survey, a voice message, a video message, or a photograph.

15. The computer-readable storage medium of claim 10, wherein the incorporated feedback is to be processed using an artificial intelligence analysis to generate and output the recommendation.

16. The computer-readable storage medium of claim 10, wherein the patient digital twin is to generate at least one of a pre-operative smart protocol to prepare the first patient for the procedure or a post-operative smart protocol to guide the patient after the procedure.

17. The computer-readable storage medium of claim 10, wherein the patient digital twin is to interact with clinical services and supporting functionality including at least one of clinical validation, notification, configuration, or data gateway services.

18. A method comprising:
generating, using a processor, a patient digital twin of a first patient, the patient digital twin including a data structure created from a combination of patient electronic medical record data and historical information, the combination extracted from one or more information systems and arranged in the data structure to form a digital representation of the first patient, the patient digital twin arranged for query and simulation via the processor;
receiving, via the patient digital twin, feedback regarding the first patient following a procedure conducted on the first patient;
incorporating, via the patient digital twin, the feedback into the patient digital twin when elements for the procedure have been completed; and
processing, via the patient digital twin, the incorporated feedback to generate and output a recommendation for follow-up with respect to the first patient based on the digital representation of the first patient including the incorporated feedback with respect to the procedure conducted on the first patient.

19. The method of claim 18, further including filtering, via the patient digital twin, the feedback based on elements completed for the procedure to form the incorporated feedback.

20. The method of claim 18, further including identifying, using the patient digital twin, a post-operative issue for the first patient based on a comparison of the feedback to a reference value and triggering a follow-up appointment for the first patient when the post-operative issue is identified.

21. The method of claim 18, further including generating, using the patient digital twin, at least one of a pre-operative smart protocol to prepare the first patient for the procedure or a post-operative smart protocol to guide the patient after the procedure.
